(19) United States
(12) Patent Application Publication
(10) Pub. No.: US 2024/0313958 A1
(43) Pub. Date: Sep. 19, 2024

(54) INFORMATION PROCESSING SYSTEM, METHOD, AND DEVICE, AND STORAGE MEDIUM

(71) Applicant: HUAWEI TECHNOLOGIES CO., LTD., Shenzhen (CN)

(72) Inventors: Jie DING, Beijing (CN); Rui ZHANG, Beijing (CN); Caijun WU, Shenzhen (CN)

(21) Appl. No.: 18/672,225

(22) Filed: May 23, 2024

Related U.S. Application Data
(63) Continuation of application No. PCT/CN2022/123841, filed on Oct. 8, 2022.

(30) Foreign Application Priority Data
Nov. 25, 2021 (CN) 202111415970.4
Jan. 24, 2022 (CN) 202210080192.6

(51) Int. Cl. H04L 9/08; G06V 40/16; G06V 40/50

(52) U.S. Cl. CPC H04L 9/0861; G06V 40/168; G06V 40/53

(57) ABSTRACT

The present disclosure relates to information processing systems, methods, devices, and storage mediums. In one example method, a first node stores a private key and public object information, and a second node stores information obtained by encryption based on a public key of the first node. When feature information of an object is not sent out from a client, a plurality of nodes interact with each other based on an information mapping relationship.

### CROSS-REFERENCE TO RELATED APPLICATIONS

This application is a continuation of International Application No. PCT/CN2022/123841, filed on Oct. 8, 2022, which claims priority to Chinese Patent Application No. 202210080192.6, filed on Jan. 24, 2022, and Chinese Patent Application No. 202111415970.4, filed on Nov. 25, 2021. All of the aforementioned patent applications are hereby incorporated by reference in their entireties.

### TECHNICAL FIELD

This application relates to the field of computer technologies, and in particular, to an information processing system, method, and device, and a storage medium.

### BACKGROUND

With the advent of the big data era, unique and private user information, for example, face information, is commonly used for user identity recognition. To protect user information from being disclosed, currently, when face verification is performed based on a one-to-one information processing process, face information is usually encrypted on a client. In this way, a server needs to rely on a key generated by the client to compare encrypted face information with known face information.

However, in the foregoing technical solution, when a more complex information processing requirement is faced, for example, when face recognition needs to be implemented based on a one-to-many information processing process, security of user information cannot be ensured. Therefore, there is an urgent need for an information processing method, so that user information security of can be effectively ensured in a process of performing information processing based on user information.

### SUMMARY

This application provides an information processing system, method, and device, and a storage medium, so that information security can be effectively ensured. The technical solution is as follows:

According to a first aspect, an information processing system is provided. The information processing system includes: a client, a first node, and a second node.

The client is configured to: send, to the first node, a recognition request that carries number information of the client, and send an encryption feature of a to-be-recognized first object and the number information of the client to the second node, where the encryption feature of the first object is obtained based on a public key of the first node and a feature of the first object.

The first node is configured to: determine a first target file in the second node in response to the recognition request, and send a recognition indication to the second node, where the recognition indication carries the number information of the client and file information of the first target file.

The second node is configured to: in response to the recognition indication, compare the encryption feature of the first object based on the received encryption feature of the first object, the number information of the client, the file information of the first target file, and an evaluation key of the first node, to obtain a comparison result, and send the comparison result to the first node.

The first node is further configured to: when receiving the comparison result, decrypt the comparison result based on a private key of the first node, obtain object information of the first object based on a decrypted comparison result, and send the object information of the first object to the client.

The object information includes information used to identify an object in the information processing system. For example, in a facial recognition scenario, the object information refers to a user name input when a user registers with a facial recognition system. In some other embodiments, the object information includes identity information of an object. For example, in a facial recognition scenario, the object information includes a name, an age, an identity card number, and the like that are input when a user registers with a facial recognition system.

According to the foregoing technical solution, the first node stores the private key and public object information, and the second node stores information obtained by encryption based on the public key of the first node. This ensures separation of storage permission and decryption permission. When feature information of an object is not sent out from the client, a plurality of nodes interact with each other based on an information mapping relationship. This may implement efficient information processing and effectively ensure information security. In addition, according to the foregoing technical solution, one-to-many information recognition may be implemented based on a set of keys. This effectively resolves a problem that a large quantity of storage spaces are occupied to store a plurality of sets of keys corresponding to a plurality of registered features.

In a possible implementation, the client is further configured to: perform encoding based on the feature of the first object, to obtain a first feature vector of the first object, where the first feature vector is an M-dimensional vector;
obtain a second feature vector of the first object based on the first feature vector of the first object, where the second feature vector of the first object is N×M-dimensional vectors, and the second feature vector of the first object includes N first feature vectors of the first object; and
encrypt the second feature vector of the first object based on the public key of the first node, to obtain the encryption feature of the first object, where
M and N are positive integers.

In the foregoing technical solution, in a process of performing information recognition, a feature of a to-be-recognized object is encoded as a multi-dimensional vector that matches a dimension of the first target file, so that the feature of the to-be-recognized object can be compared with a plurality of registered objects in parallel. This is equivalent to completing an information processing process for the plurality of registered objects in one processing periodicity, so that information processing efficiency is greatly improved.

In a possible implementation, the second node includes a scheduling node and a plurality of target nodes.

The first node is configured to: determine, in a file information table based on the number information of the client in the recognition request, a first target node that corresponds to the client and that is in the second node, and determine, in the file information table, the file information of the first target file in the first target node, where the file information table includes a correspondence between the number information of the client and the plurality of target nodes included in the second node, and a correspondence between the plurality of target nodes and files.

In a possible implementation, the scheduling node in the second node is configured to: in response to the recognition indication, indicate the first target node to load the evaluation key of the first node into memory.

In the foregoing technical solution, when receiving the recognition indication, the first target node directly loads the evaluation key, so that when receiving the encryption feature sent by the client, the first target node may directly perform recognition based on the evaluation key in the memory. This reduces time for loading the evaluation key in a recognition process.

According to the foregoing technical solution, a physical data parallel processing capability of a multi-node architecture of the information processing system is fully utilized, and information processing efficiency is greatly improved.

In a possible implementation, the scheduling node in the second node is configured to: in response to the recognition indication, send the recognition indication and the encryption feature of the first object to the first target node in the second node based on the file information of the first target file and the number information of the client.

In response to the recognition indication, the first target node compares the encryption feature of the first object based on the received encryption feature of the first object, the first target file, and the evaluation key of the first node, to obtain the comparison result.

According to the foregoing technical solution, the scheduling node in the second node can schedule the plurality of target nodes in parallel based on an indication of the first node, recognize the client, and implement a physical parallel operation by using a correspondence between the target node and a number of the client, so that real-time information recognition is ensured while information processing efficiency is improved.

In a possible implementation, the scheduling node in the second node is configured to: in response to the recognition indication, send the recognition indication and the encryption feature of the first object to the first target node in the second node based on the file information of the first target file when the number information received from the client is consistent with the number information of the client carried in the recognition indication.

In the foregoing technical solution, consistency verification is performed on number information from two different sources, so that information security is effectively ensured.

In a possible implementation, the first target node in the second node is configured to perform, in a ciphertext state based on the evaluation key of the first node, an inner product operation on the received encryption feature of the first object and each registered feature in the first target file, to obtain the comparison result.

In a possible implementation, the first node is configured to: determine a target feature based on the decrypted comparison result, where the target feature is a registered feature with a maximum similarity to the feature of the first object;
obtain object information of the target feature from the file information table based on location information of the target feature in the first target file, where the file information table includes object information of each registered feature in a file in the second node and location information of each registered feature in the file in the second node; and
determine the object information of the target feature as the object information of the first object.

In a possible implementation, the client is further configured to send a registration request to the first node, where the registration request carries the number information of the client and object information of a to-be-registered second object.

The first node is further configured to: in response to the registration request, determine a second target file in a second target node in the second node, send file information of the second target file to the client, and send a registration indication to the second node, where the registration indication carries the number information of the client and the file information of the second target file.

The client is further configured to send an encryption feature of the second object and the number information of the client to the second node, where the encryption feature of the second object is obtained based on the public key of the first node, a feature of the second object, and the file information of the second target file.

The second node is further configured to: in response to the registration indication, add the encryption feature of the second object to the second target file through the second target node based on the received encryption feature of the second object, the number information of the client, the file information of the second target file, and the evaluation key of the first node, and send addition success information to the first node.

The first node is further configured to: when receiving the addition success information, add the object information of the second object to the file information table, and send registration success information to the client, where the file information table includes the object information of each registered feature in the file in the second node and the location information of each registered feature in the file in the second node.

In a possible implementation, the file information of the second target file includes a vacant location number of the second target file.

The client is further configured to: encode the feature of the second object, to obtain a first feature vector of the second object, where the first feature vector of the second object is an M-dimensional vector;
obtain a second feature vector of the second object based on the first feature vector of the second object and the vacant location number, where the second feature vector of the second object is N×M-dimensional vectors, the first feature vector of the second object is located at a location that corresponds to the vacant location number and that is in the second feature vector of the second object, and a location other than the location that corresponds to the vacant location number and that is in the second feature vector of the second object is 0; and
encrypt the second feature vector of the second object based on the public key of the first node, to obtain the encryption feature of the second object, where
M and N are positive integers.

According to the foregoing technical solution, in a registration process, registration encoding is used to ensure that registration is performed based on a vacant location in the second target file corresponding to the to-be-registered object, and the registration process does not affect another registered feature. This implements dynamic registration in an encrypted state, improves flexibility of information processing, and improves information processing efficiency on a basis of ensuring information security.

In a possible implementation, the client is further configured to send a deregistration request to the first node, where the deregistration request carries the number information of the client and object information of a to-be-deregistered third object.

The first node is further configured to: in response to the deregistration request, determine a third target file in which a registered feature corresponding to the third object is located in a third target node in the second node, and send a deregistration indication to the second node, where the deregistration indication carries the number information of the client and file information of the third target file, the file information of the third target file includes a location number, in the third target file, of the registered feature corresponding to the third object.

The second node is further configured to: in response to the deregistration indication, delete, from the third target file through the third target node based on the number information of the client, the file information of the third target file, and the evaluation key of the first node, the registered feature corresponding to the third object, and send deletion success information to the first node.

The first node is further configured to: when receiving the deletion success information, delete, from the file information table, the object information of the third object and location information, in the third target file, of the registered feature corresponding to the third object, and send deregistration success information to the client, where the file information table includes the object information of each registered feature in the file in the second node and the location information of each registered feature in the file in the second node.

According to the foregoing technical solution, in a process of performing information deregistration, based on the information mapping relationship stored in the file information table, it is ensured that deregistration is performed on the registered feature of the to-be-deregistered object, and the deregistration process does not affect another registered feature. This implements dynamic deregistration in an encrypted state, improves flexibility of information processing, and improves information processing efficiency on a basis of ensuring information security.

According to a second aspect, an information processing system is provided. The information processing system includes: a client, a third node, and a fourth node.

The client is configured to send, to the third node, a recognition request that carries number information of the client and an encryption feature of a to-be-recognized first object, where the encryption feature of the first object is obtained based on a public key of the third node and a feature of the first object.

The third node is configured to: in response to the recognition request, determine file information of a first target file in the third node, compare the encryption feature of the first object based on the received encryption feature of the first object, the file information of the first target file, and an evaluation key of the third node, to obtain a comparison result, and send the comparison result to the fourth node.

The fourth node is configured to: when receiving the comparison result, decrypt the comparison result based on a private key of the third node, and send a decrypted comparison result to the third node.

The third node is further configured to obtain object information of the first object based on the received decrypted comparison result, and send the object information of the first object to the client.

According to the foregoing technical solution, the third node stores information encrypted based on a public key and public object information, and the fourth node stores the private key. This ensures separation of storage permission and decryption permission. When feature information of an object is not sent out from the client, a plurality of nodes interact with each other based on an information mapping relationship. This may implement efficient information processing and effectively ensure information security. Further, the fourth node is only used to provide a decryption service. A process of information exchange between the plurality of nodes is simplified, and information processing efficiency is effectively improved.

In a possible implementation, the client is further configured to: perform encoding based on the feature of the first object, to obtain a first feature vector of the first object, where the first feature vector is an M-dimensional vector;
obtain a second feature vector of the first object based on the first feature vector of the first object, where the second feature vector of the first object is N×M-dimensional vectors, and the second feature vector of the first object includes N first feature vectors of the first object; and
encrypt the second feature vector based on the public key of the third node, to obtain the encryption feature of the first object, where
M and N are positive integers.

In a possible implementation, the third node is configured to determine the file information of the first target file in a file information table based on the number information of the client in the recognition request, where the file information table includes a correspondence between the number information of the client and a file in the third node.

In a possible implementation, the third node is configured to: in response to the recognition request, load the evaluation key of the third node into memory.

In a possible implementation, the third node is configured to: in response to the recognition request, determine the file information of the first target file in the third node based on the number information of the client; and
compare the encryption feature of the first object based on the received encryption feature of the first object, the first target file, and the evaluation key of the third node, to obtain the comparison result.

In a possible implementation, the third node is configured to perform, based on the evaluation key of the third node, an inner product operation on the received encryption feature of the first object and each registered feature in the first target file, to obtain the comparison result.

In a possible implementation, the third node is configured to: determine a target feature based on the decrypted comparison result, where the target feature is a registered feature with a maximum similarity to the feature of the first object;
obtain object information of the target feature from the file information table based on location information of the target feature in the first target file, where the file information table includes object information of each registered feature in the file in the third node and location information of each registered feature in the file in the third node; and
determine the object information of the target feature as the object information of the first object.

In a possible implementation, the client is further configured to send a registration request to the third node, where the registration request carries the number information of the client and object information of a to-be-registered second object.

The third node is further configured to: in response to the registration request, determine a second target file in the third node based on the number information of the client, and send file information of the second target file to the client.

The client is further configured to send an encryption feature of the second object to the third node, where the encryption feature of the second object is obtained based on the public key of the third node, a feature of the second object, and the file information of the second target file.

The third node is further configured to add the encryption feature of the second object to the second target file based on the received encryption feature of the second object, the file information of the second target file, and the evaluation key of the third node.

The third node is further configured to: when successfully adding the encryption feature of the second object, add the object information of the second object to the file information table, and send registration success information to the client, where the file information table includes the object information of each registered feature in the file in the third node and the location information of each registered feature in the file in the third node.

In a possible implementation, the file information of the second target file includes a vacant location number of the second target file.

The client is further configured to: encode the feature of the second object, to obtain a first feature vector of the second object, where the first feature vector of the second object is an M-dimensional vector;
obtain a second feature vector of the second object based on the first feature vector of the second object and the vacant location number, where the second feature vector of the second object is N×M-dimensional vectors, the first feature vector of the second object is located at a location that corresponds to the vacant location number and that is in the second feature vector of the second object, and a location other than the location that corresponds to the vacant location number and that is in the second feature vector of the second object is 0; and
encrypt the second feature vector of the second object based on the public key of the third node, to obtain the encryption feature of the second object, where
M and N are positive integers.

In the foregoing technical solution, in a process of performing information registration, registration encoding is used to ensure that registration is performed based on a vacant location in the second target file corresponding to the to-be-registered object, and the registration process does not affect another registered feature. This implements dynamic registration in an encrypted state, improves flexibility of information processing, and improves information processing efficiency on a basis of ensuring information security.

In a possible implementation, the client is further configured to send a deregistration request to the third node, where the deregistration request carries the number information of the client and object information of a to-be-deregistered third object.

The third node is further configured to: in response to the deregistration request, determine a third target file in which a registered feature corresponding to the third object is located in the plurality of third nodes.

The third node is further configured to delete, from the third target file based on file information of the third target file and the evaluation key of the third node, the registered feature corresponding to the third object, where the file information of the third target file includes a location number, in the third target file, of the registered feature corresponding to the third object.

The third node is further configured to: when successfully deleting the registered feature corresponding to the third object, delete, from the file information table, the object information of the third object and location information, in the third target file, of the registered feature corresponding to the third object, and send deregistration success information to the client, where the file information table includes the object information of each registered feature in the file in the third node and the location information of each registered feature in the file in the third node.

According to the foregoing technical solution, in a process of performing information deregistration, based on the information mapping relationship stored in the file information table, it is ensured that deregistration is performed on the registered feature of the to-be-deregistered object, and the deregistration process does not affect another registered feature. This implements dynamic deregistration in an encrypted state, improves flexibility of information processing, and improves information processing efficiency on a basis of ensuring information security.

According to a third aspect, an information processing method is provided. The method is performed by a client in an information processing system, the information processing system further includes a first node and a second node, and the method includes:
sending, to the first node, a recognition request that carries number information of the client;
sending an encryption feature of a to-be-recognized first object and the number information of the client to the second node, where the encryption feature of the first object is obtained based on a public key of the first node and a feature of the first object; and
receiving object information of the first object from the first node, where the object information of the first object is obtained based on the encryption feature of the first object, an evaluation key of the first node, and a private key of the first node.

In a possible implementation, before the sending an encryption feature of a to-be-recognized first object and the number information of the client to the second node, the method further includes:
performing encoding based on the feature of the first object, to obtain a first feature vector of the first object, where the first feature vector is an M-dimensional vector;
obtaining a second feature vector of the first object based on the first feature vector of the first object, where the second feature vector of the first object is N×M-dimensional vectors, and the second feature vector of the first object includes N first feature vectors of the first object; and
encrypting the second feature vector of the first object based on the public key of the first node, to obtain the encryption feature of the first object, where
M and N are positive integers.

In a possible implementation, the method further includes:
sending a registration request to the first node, where the registration request carries the number information of the client and object information of a to-be-registered second object;
sending an encryption feature of the second object and the number information of the client to the second node, where the encryption feature of the second object is obtained based on the public key of the first node, a feature of the second object, and file information of a second target file in the second node, and the file information of the second target file is determined by the first node in response to the registration request; and
receiving registration success information from the first node.

In a possible implementation, the file information of the second target file includes a vacant location number of the second target file, and before the sending an encryption feature of the second object and the number information of the client to the second node, the method further includes:
performing encoding based on the feature of the second object, to obtain a first feature vector of the second object, where the first feature vector of the second object is an M-dimensional vector;
obtaining a second feature vector of the second object based on the first feature vector of the second object and the vacant location number, where the second feature vector of the second object is N×M-dimensional vectors, the first feature vector of the second object is located at a location that corresponds to the vacant location number and that is in the second feature vector of the second object, and a location other than the location that corresponds to the vacant location number and that is in the second feature vector of the second object is 0; and
encrypting the second feature vector of the second object based on the public key of the first node, to obtain the encryption feature of the second object, where
M and N are positive integers.

In a possible implementation, the method further includes:
sending a deregistration request to the first node, where the deregistration request carries the number information of the client and object information of a to-be-deregistered third object; and
receiving deregistration success information from the first node.

According to a fourth aspect, an information processing method is provided. The method is performed by a first node in an information processing system, the information processing system further includes a client and a second node, and the method includes:
determining a first target file in the second node in response to a recognition request that is received from the client and that carries number information of the client, and sending a recognition indication to the second node, where the recognition indication carries the number information of the client and file information of the first target file; and
when receiving a comparison result from the second node, decrypting the comparison result based on a private key of the first node, obtaining object information of a first object based on a decrypted comparison result, and sending the object information of the first object to the client, where
the comparison result is obtained by performing, by the second node in response to the recognition indication, comparison on an encryption feature of the first object based on the encryption feature of the first object, the number information of the client, the file information of the first target file, and an evaluation key of the first node; and the encryption feature of the first object is obtained by the client based on a public key of the first node and a feature of the first object.

In a possible implementation, the second node includes a scheduling node and a plurality of target nodes, and the determining a first target file in the second node in response to a recognition request that is received from the client and that carries number information of the client includes:
determining, in a file information table based on the number information of the client in the recognition request, a first target node that corresponds to the client and that is in the second node, and determining, in the file information table, the file information of the first target file in the first target node, where the file information table includes a correspondence between the number information of the client and the plurality of target nodes included in the second node, and a correspondence between the plurality of target nodes and files.

In a possible implementation, the obtaining object information of a first object based on a decrypted comparison result includes:
determining, by the first node, a target feature based on the decrypted comparison result, where the target feature is a registered feature with a maximum similarity to the feature of the first object;
obtaining object information of the target feature from the file information table based on location information of the target feature in the first target file, where the file information table includes object information of each registered feature in a file in the second node and location information of each registered feature in the file in the second node; and
determining the object information of the target feature as the object information of the first object.

In a possible implementation, the method further includes:
in response to a registration request received from the client, determining a second target file in a second target node in the second node, sending file information of the second target file to the client, and sending a registration indication to the second node, where the registration request carries the number information of the client and object information of a to-be-registered second object, and the registration indication carries the number information of the client and the file information of the second target file; and
when receiving addition success information from the second node, adding the object information of the second object to the file information table, and sending registration success information to the client, where the file information table includes the object information of each registered feature in the file in the second node and the location information of each registered feature in the file in the second node, and the addition success information indicates that an encryption feature of the second object has been added to the second target file.

In a possible implementation, the method further includes:
in response to a deregistration request received from the client, determining a third target file in which a registered feature corresponding to a third object is located in a third target node in the second node, and sending a deregistration indication to the second node, where the deregistration indication carries the number information of the client and file information of the third target file, and the deregistration request carries the number information of the client and object information of the to-be-deregistered third object; and
when receiving deletion success information from the second node, deleting, from the file information table, the object information of the third object and location information, in the third target file, of the registered feature corresponding to the third object, and sending deregistration success information to the client, where the file information table includes the object information of each registered feature in the file in the second node and the location information of each registered feature in the file in the second node, and the deletion success information indicates that the registered feature corresponding to the third object has been deleted from the third target file.

According to a fifth aspect, an information processing method is provided. The method is performed by a second node in an information processing system, the information processing system further includes a client and a first node, and the method includes:
comparing, in response to a recognition indication received from the first node, an encryption feature of a first object based on the encryption feature, of the to-be-recognized first object, that is received from the client, number information of the client, file information of a first target file in the second node, and an evaluation key of the first node, to obtain a comparison result, and sending the comparison result to the first node, where
the recognition indication carries the number information of the client and the file information of the first target file, the encryption feature of the first object is obtained based on a public key of the first node and a feature of the first object, and the comparison result is used to determine object information of the first object.

In a possible implementation, the method further includes:
in response to the recognition indication, indicating, by a scheduling node in the second node, a first target node to load the evaluation key of the first node into memory.

In a possible implementation, the second node includes the scheduling node and a plurality of target nodes, and the comparing, in response to a recognition indication received from the first node, an encryption feature of a first object based on the encryption feature, of the to-be-recognized first object, that is received from the client, number information of the client, file information of a first target file in the second node, and an evaluation key of the first node, to obtain a comparison result includes:
sending, by the scheduling node in response to the recognition indication, the recognition indication and the encryption feature of the first object to the first target node in the second node based on the file information of the first target file and the number information of the client; and
comparing, by the first target node in response to the recognition indication, the encryption feature of the first object based on the received encryption feature of the first object, the first target file, and the evaluation key of the first node, to obtain the comparison result.

In a possible implementation, the sending, in response to the recognition indication, the recognition indication and the encryption feature of the first object to the first target node in the second node includes:
sending, by the scheduling node in the second node in response to the recognition indication, the recognition indication and the encryption feature of the first object to the first target node in the second node based on the file information of the first target file when the number information received from the client is consistent with the number information of the client carried in the recognition indication.

In a possible implementation, the comparing an encryption feature of a first object based on the encryption feature, of the to-be-recognized first object, that is received from the client, number information of the client, file information of a first target file in the second node, and an evaluation key of the first node, to obtain a comparison result include:
performing, in a ciphertext state based on the evaluation key of the first node, an inner product operation on the received encryption feature of the first object and each registered feature in the first target file, to obtain the comparison result.

In a possible implementation, the method further includes:
in response to a registration indication received from the first node, adding an encryption feature of a second object to a second target file based on the encryption feature, of the to-be-registered second object, that is received from the client, the number information of the client, file information of the second target file in a second target node in the second node, and the evaluation key of the first node, and sending addition success information to the first node, where the encryption feature of the second object is obtained based on the public key of the first node, a feature of the second object, and the file information of the second target file.

In a possible implementation, the method further includes:
in response to a deregistration indication received from the first node, deleting, from a third target file based on the number information of the client, file information of the third target file in which a registered feature corresponding to a third object is located in a third target node in the second node, and the evaluation key of the first node, the registered feature corresponding to the third object, and sending deletion success information to the first node, where the deregistration indication carries the number information of the client and the file information of the third target file.

According to a sixth aspect, an information processing method is provided. The method is performed by a third node in an information processing system, the information processing system further includes a client and a fourth node, and the method includes:
in response to a recognition request received from the client, determining file information of a first target file in the third node, comparing an encryption feature of a first object based on the encryption feature, of the to-be-recognized first object, that is received from the client, the file information of the first target file, and an evaluation key of the third node, to obtain a comparison result, and sending the comparison result to the fourth node, where the recognition request carries number information of the client, and the encryption feature of the first object is obtained based on a public key of the third node and a feature of the first object; and
obtaining object information of the first object based on a decrypted comparison result received from the fourth node, and sending the object information of the first object to the client, where the decrypted comparison result is obtained by decrypting, by the fourth node, the comparison result based on a private key of the third node.

According to a seventh aspect, a computing device is provided. The computing device can include a processor and a memory. The memory is configured to store at least one segment of program code, and the at least one segment of program code is loaded by the processor and is used to perform the information processing method provided in the third aspect, or the information processing method provided in the fourth aspect, or the information processing method provided in the fifth aspect, or the information processing method provided in the sixth aspect.

According to an eighth aspect, a computer-readable storage medium is provided. The computer-readable storage medium is used to store at least one segment of program code; and when the at least one segment of program code in the computer-readable storage medium is executed by a processor of a computing device, the computing device is enabled to perform the information processing method provided in the third aspect, or the information processing method provided in the fourth aspect, or the information processing method provided in the fifth aspect, or the information processing method provided in the sixth aspect.

According to a ninth aspect, a computer program product is provided. When the computer program product runs on a computing device, the computing device is enabled to perform the information processing method provided in the third aspect, or the information processing method provided in the fourth aspect, or the information processing method provided in the fifth aspect, or the information processing method provided in the sixth aspect.

### BRIEF DESCRIPTION OF DRAWINGS

FIG. 1 is a schematic diagram of an architecture of an information processing system according to an embodiment of this application;

FIG. 2 is a schematic diagram of a hardware structure of a computing device according to an embodiment of this application;

FIG. 3A and FIG. 3B are a schematic flowchart of an information processing method according to an embodiment of this application;

FIG. 4 is a schematic diagram of a file information table according to an embodiment of this application;

FIG. 5 is a schematic diagram of a registration process according to an embodiment of this application;

FIG. 6 is a schematic diagram of a registration process according to an embodiment of this application;

FIG. 7A and FIG. 7B are a schematic flowchart of an information processing method according to an embodiment of this application;

FIG. 8 is a schematic diagram of a recognition process according to an embodiment of this application;

FIG. 9 is a schematic diagram of a recognition process according to an embodiment of this application;

FIG. 10 is a schematic flowchart of an information processing method according to an embodiment of this application;

FIG. 11 is a schematic diagram of a deregistration process according to an embodiment of this application;

FIG. 12 is a schematic diagram of an architecture of an information processing system according to an embodiment of this application;

FIG. 13 is a schematic flowchart of an information processing method according to an embodiment of this application;

FIG. 14A and FIG. 14B are a schematic flowchart of an information processing method according to an embodiment of this application;

FIG. 15 is a schematic flowchart of an information processing method according to an embodiment of this application; and

FIG. 16 is a schematic diagram of an architecture of an information processing system according to an embodiment of this application.

### DESCRIPTION OF EMBODIMENTS

To make the objectives, technical solutions, and advantages of this application clearer, the following further describes the implementations of this application in detail with reference to the accompanying drawings.

Before describing the technical solutions provided in embodiments of this application, the following first describes key terms in this application.

Face verification (face verification, FV): Face verification is a technology for determining whether two face images correspond to a same person. This is a two-class problem and is usually applied to face-based login control, access control, identity confirmation, and the like, for example, face-based mobile phone unlocking and operating system login. Face verification involves 1:1 comparison and operations.

Face recognition (face recognition, FR): A recognition system extracts a to-be-recognized face feature from an input face image, and compares and searches in a face database based on the to-be-recognized face feature. If a similarity between the to-be-recognized face feature and a known face image, in the face database, that is the closest to the to-be-recognized face feature is greater than a specific threshold, it is determined that the input face image and the known face image correspond to a same face; otherwise, it is considered that the input face image corresponds to an unknown face. Face recognition is usually used for face-based attendance clocking and personnel search. Face recognition involves 1:N comparison and operations. Compared with face verification, operation workload of face recognition is much larger, and specifically depends on a quantity N of registered faces in the recognition system, where N is a positive integer.

Homomorphic encryption (homomorphic encryption, HE): A homomorphic encryption technology may implement a homomorphic operation on a ciphertext state of data. A result of decrypting an operation result of the ciphertext state is equivalent to a result of performing a corresponding operation on a plaintext. This enables the data to be vacant and invisible. Full homomorphic encryption (full homomorphic encryption, FHE) supports any form of operation (including addition and multiplication) on a ciphertext.

Key (secret key, SK): The key is a parameter input in converting a plaintext to a ciphertext (an encryption algorithm) or converting a ciphertext to a plaintext (a decryption algorithm). In a homomorphic encryption technology, a key generated by using a key generation algorithm includes a group including a public key, a private key, and an evaluation key. The public key (public key, PK) is a public parameter, and can be used to encrypt a plaintext to obtain a ciphertext. The private key (private key, PK) is a non-public parameter, and is used to decrypt a ciphertext that is encrypted based on the public key. The evaluation key (evaluation key, EK) is also referred to as an auxiliary calculation key, is used to perform a homomorphic operation (for example, ciphertext multiplication) on a ciphertext, and includes a re-linearization key and a key-switching key. The re-linearization key is used to prevent ciphertext expansion. The key-switching key is used to support a ciphertext rotation operation. The evaluation key can ensure that a result of performing decryption on a result of performing an operation on a ciphertext is equivalent to a result of performing a corresponding operation on a plaintext.

Hierarchical fully homomorphic CKKS algorithm: The CKKS (Cheon-Kim-Kim-Song) algorithm is an approximate computation homomorphic encryption algorithm, and supports floating-point number addition and multiplication homomorphic operations for real or complex numbers. Calculation results obtained are approximate values, and are applicable to scenarios of machine learning model training and the like in which accurate results are not required.

Hierarchical fully homomorphic BFV algorithm: The BFV (Brakerski/Fan-Vercauteren) algorithm is a homomorphic encryption algorithm that supports any form of operation on a ciphertext, and may be constructed based on learning with error (learning with error, LWE) and ring learning with error (ring learning with error, RLWE). In the BFV algorithm, a ciphertext and a key are both represented by vectors, and a product of the ciphertext and the corresponding key is a tensor. Therefore, a ciphertext multiplication operation causes an explosive increase in a number of dimensions of the ciphertext. The BFV algorithm uses a key switching technology, to control expansion of the number of dimensions of the ciphertext vector, so that an expanded number of dimensions of the ciphertext can be restored to an original number of dimensions of the ciphertext through key switching after ciphertext calculation is performed.

Open multi-processing (Open multi-processing, OpenMP) is a set of compiler instructions and library functions, and is designed for parallel programming on shared storage computing devices.

A field programmable gate array (field programmable gate array, FPGA) is a hardware carrier that specifically implements a given function and a technical index of an electronic application system by using an electronic design automation technology. FPGA is one of mainstream devices to implement this approach, and is featured by direct-to-user, high flexibility and great versatility, convenient use and quick implementation, and the like.

An FPGA accelerator card is a professional board for specific fields and applications, and is designed with rich high-speed I/O interfaces and storage resources. The FPGA accelerator card can effectively improve data processing efficiency during hardware development.

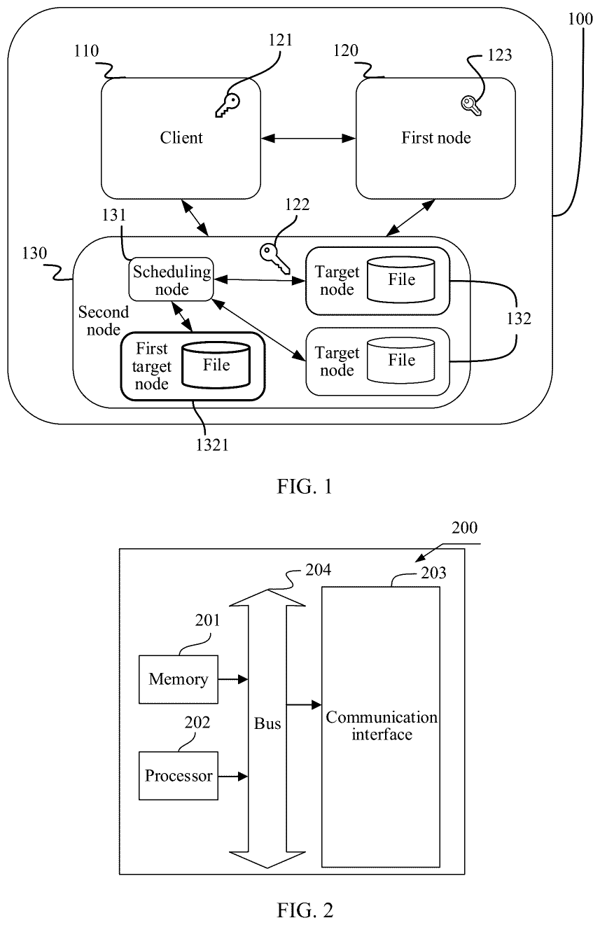

FIG. 1 is a schematic diagram of an architecture of an information processing system according to an embodiment of this application. As shown in FIG. 1, the information processing system 100 includes: a client 110, a first node 120, and a second node 130, where the second node 130 includes a scheduling node 131 and a plurality of target nodes 132.

The client 110 is configured to: when detecting a to-be-recognized object, obtain a feature of the to-be-recognized object, encrypt the obtained feature of the to-be-recognized object based on a public key 121 of the first node 120 to obtain an encryption feature, and send the encryption feature to the second node; and send a recognition request to the first node 120, to indicate the first node to obtain file information required for recognizing the to-be-recognized object.

The first node 120 is configured to store a file information table, obtain, based on the received recognition request, the file information of a file required for recognizing the to-be-recognized object, and send a recognition indication to the second node 130 based on the file information. The recognition indication indicates a first target node 1321 that corresponds to the client and that is in the second node 120, to recognize the client 110.

The scheduling node 131 in the second node 130 is configured to: in response to receiving the recognition indication of the first node, send, to the first target node 1321 corresponding to the client, the recognition indication and the encryption feature that is received from the client node. The first target node 1321 in the second node 130 is configured to: store a file in which a registered feature is located, in response to receiving the recognition indication and the encryption feature, compare the encryption feature based on an evaluation key 122 of the first node 120 and the stored file, to obtain a comparison result, and send the comparison result to the first node 120.

The first node 120 is further configured to: decrypt the received comparison result based on a private key 123 of the first node 120, determine object information (for example, identity information) of the to-be-recognized object based on a decrypted comparison result, and send the object information to the client 110.

The client 110, the first node 120, and the second node 130 are communicatively connected through a wired network or a wireless network. In some embodiments, the foregoing wireless network or wired network uses a standard communication technology and/or protocol. The network is usually the internet, but can also be any network including, but not limited to, a local area network (local area network, LAN), a metropolitan area network (metropolitan area network, MAN), a wide area network (wide area network, WAN), or any combination of a mobile, wired, or wireless network, a private network, or a virtual private network. In some embodiments, peer-to-peer (peer-to-peer, P2P) communication is implemented between the client 110, the first node 120, and the second node 130 based on a remote procedure call protocol (remote procedure call protocol, RPC). In some embodiment, the client 110, the first node 120, and the second node 130 use a technology and/or a format including the hyper text markup language (hyper text markup language, HTML), the extensible markup language (extensible markup language, XML), and the like to represent data exchanged through a network. In addition, the client 110, the first node 120, and the second node 130 can also use conventional encryption technologies of the secure socket layer (secure socket layer, SSL), the transport layer security (transport layer security, TLS), the virtual private network (virtual private network, VPN), the internet protocol security (internet protocol security, IPsec), and the like, to encrypt all or some links. In some other embodiments, custom and/or dedicated data communication technologies can also be used to place or supplement the data communication technologies described above.

In some embodiments, the client is a terminal or a server on a user side. The terminal is also referred to as an intelligent terminal or a mobile intelligent terminal, and refers to a type of device that has rich human-computer interaction manners, has an internet access capability, usually carries various operating systems, and has a strong processing capability. In some embodiments, a type of the mobile intelligent terminal includes but is not limited to a smartphone, a tablet computer, a vehicle-mounted terminal, a handheld game console, and the like. The server may be a server cluster including one or more computing devices.

In some embodiments, the first node and the second node may be independent physical servers, or may be server clusters or distributed systems including a plurality of physical servers, or may be cloud servers that provide basic cloud computing services of cloud services, cloud databases, cloud computing, cloud functions, cloud storage, network services, cloud communication, middleware services, domain name services, security services, content delivery networks (content delivery networks, CDNs), big data, artificial intelligence platforms, and the like.

With reference to FIG. 1, the architecture of the information processing system provided in embodiments of this application is described from a perspective of a system architecture. The following describes hardware structures of a client, a first node, and a second node in the information processing system.

An embodiment of this application provides a computing device that can be configured as any one of the client, the first node, or the second node in the foregoing information processing system. For example, FIG. 2 is a schematic diagram of a hardware structure of a computing device according to an embodiment of this application. As shown in FIG. 2, the computing device 200 includes a memory 201, a processor 202, a communication interface 203, and a bus 204. The memory 201, the processor 202, and the communication interface 203 are communicatively connected to each other through the bus 204.

The memory 201 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or other compact disc storage, optical disc storage (including a compact disc, a laser disc, an optical disc, a digital versatile disc, a Blu-ray disc, and the like), a magnetic disk storage medium or another magnetic storage device, or any other medium that can be used to carry or store expected program code in a form of an instruction or a data structure and that is accessible to a computer. However, this is not limited herein. The memory 201 may store at least one segment of program code. When the program code stored in the memory 201 is executed by the processor 202, the computing device can implement an operation performed by the client in the information processing system. The memory 201 may store a feature of an object, a public key, and the like. This is not limited in this embodiment of this application.

The processor 202 may be a network processor (network processor, NP), a central processing unit (central processing unit, CPU), an application-specific integrated circuit (application-specific integrated circuit, ASIC), or an integrated circuit configured to control program execution of the solutions in this application. The processor 202 may be a single-core (single-CPU) processor, or may be a multi-core (multi-CPU) processor. There may be one or more processors 202. The communication interface 203 uses a transceiver module, for example, a transceiver, to implement communication between the computing device 200 and another device or a communication network. For example, data may be obtained through the communication interface 203.

The memory 201 and the processor 202 may be separately disposed, or may be integrated together.

The bus 204 may include a path for transferring information between various components (for example, the memory 201, the processor 202, and the communication interface 203) of the computing device 200.

The following describes an information processing method provided in embodiments of this application. The method can be applied to the foregoing information processing system.

In embodiments of this application, the public key, the private key, and the evaluation key that are deployed in the information processing system are determined by using a key generation algorithm based on a processing requirement parameter in the system. In some embodiments, the processing requirement parameter includes: (1) dimension information of the feature of the object, where a key generated based on the dimension information of the feature can ensure accuracy of a homomorphic operation performed on an encryption feature of the object based on the evaluation key; (2) a security strength parameter, where the security strength parameter can determine complexity of an encryption algorithm and a decryption algorithm; (3) a recognition performance requirement, where the recognition performance requirement is used to construct an encryption algorithm, a decryption algorithm, and a key that meet a performance requirement; and (4) a maximum quantity of features, where the maximum quantity of features indicates an upper limit of a quantity of features that can be stored in the information processing system. A process of determining the public key, the private key, and the evaluation key by using the key generation algorithm is performed by the first node. The first node configures the public key for the client, where the public key is used to encrypt the obtained feature of the object; and configures the evaluation key for the second node, where the evaluation key is used to perform a homomorphic operation on the encrypted feature (ciphertext). In some embodiments, the first node can configure the public key and the evaluation key for any node. This is not limited in embodiments of this application.

The private key is held only by the first node. To be specific, the first node can decrypt encrypted information in the information processing system. In some embodiments, the first node stores the private key in secure hardware, for example, a trusted execution environment (trusted execution environment, TEE), to ensure security of the private key.

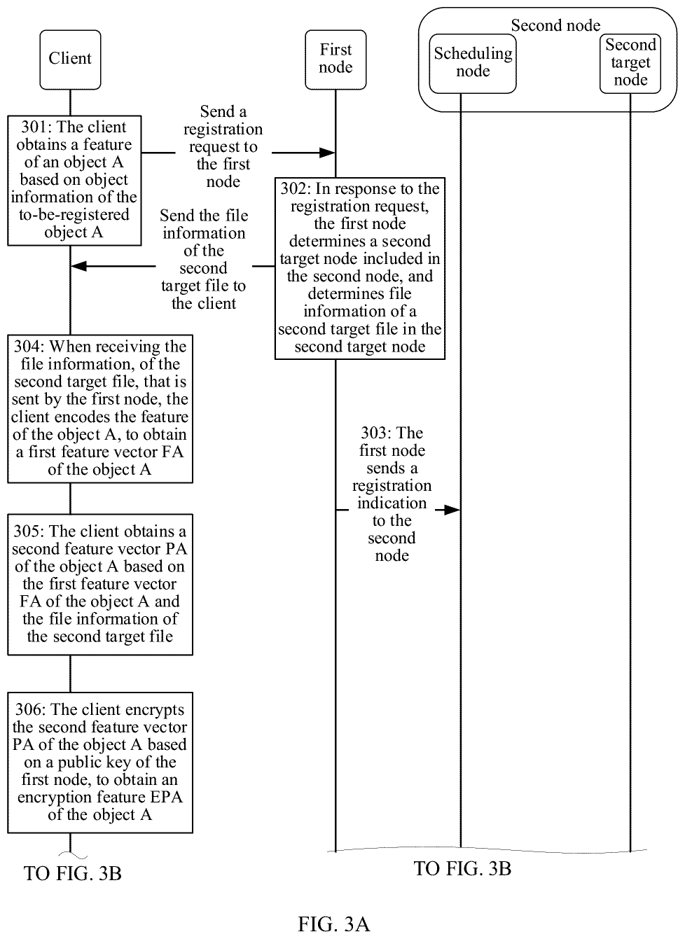

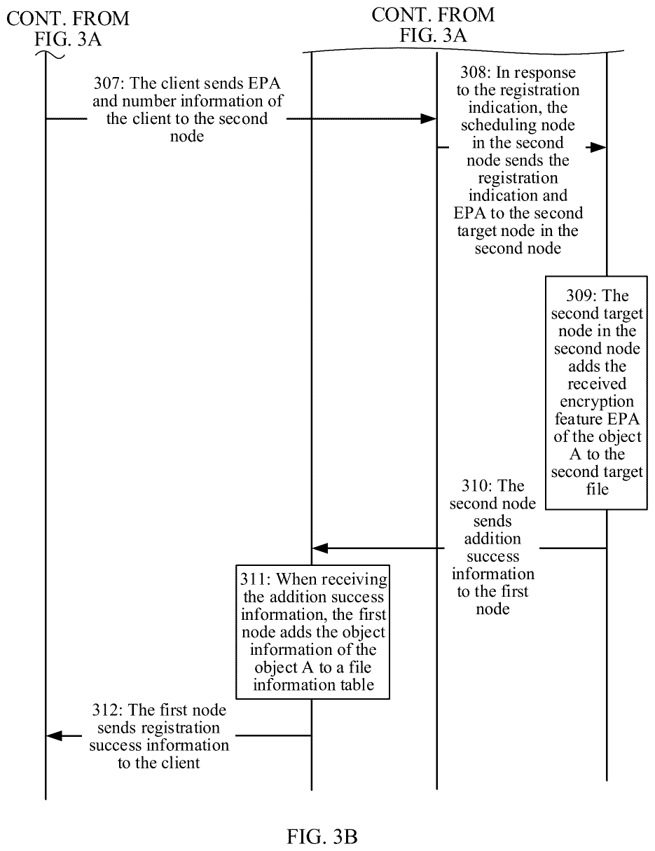

In embodiments of this application, when parameters of the public key, the private key, the evaluation key, and the like have been deployed in the information processing system, the information processing method provided in embodiments of this application may be implemented based on the information processing system. The following describes a process of performing information registration on a to-be-registered object in the information processing method provided in embodiments of this application. FIG. 3A and FIG. 3B are a schematic flowchart of an information processing method according to an embodiment of this application. As shown in FIG. 3A and FIG. 3B, the method includes the following steps.

301: A client sends a registration request to a first node based on object information of a to-be-registered object A, to obtain a feature of the object A, where the registration request carries number information of the client and the object information of the object A.

The number information of the client can uniquely identify the client, and the number information and the object information of the object A are carried in the registration request, so that a specific client that the registration request is from can be indicated.

In some embodiments, the object information includes information used to identify an object in an information processing system. For example, in a facial recognition scenario, the object information refers to a user name input when a user registers with a facial recognition system. In some other embodiments, the object information includes identity information of an object. For example, in a facial recognition scenario, the object information includes a name, an age, an identity card number, and the like that are input when a user registers with a facial recognition system.

302: In response to the registration request, the first node determines a second target node included in the second node, determines file information of a second target file in the second target node, and sends the file information of the second target file to the client.

In this embodiment of this application, the second node is configured to store a file. The file includes a plurality of registered features, and the registered features correspond to a registered object. It may be understood that all the registered features stored in the second node are encryption features of the registered object.

In some embodiments, the second node includes a scheduling node and a plurality of target nodes. The scheduling node is configured to: in response to receiving an indication, forward the indication and related information to a target node corresponding to the indication. The plurality of target nodes are respectively configured to store the registered features corresponding to the registered object. In some embodiments, files stored by the target nodes respectively include different registered objects. For example, in a facial recognition-based scenario, a plurality of departments in a same enterprise correspond to different target nodes, and each target node is configured to store a registered face file of the department. In this example, when receiving the registration request, for the object A, that is initiated by the client, the first node needs to determine the second target node that corresponds to the client and that is in the second node, and then obtain, through the second target node, the second target file required for performing registration based on the client. For example, in the facial recognition-based scenario, when registration is performed by the client, after receiving the registration request of the client, the first node determines, based on department information carried in the registration request, the second target node corresponding to the department, and then stores a facial feature carried in the registration request in the registered face file corresponding to the department.

In some embodiments, the first node stores a file information table. The file information table includes a correspondence between the number information of the client and the plurality of target nodes included in the second node, and a correspondence between the plurality of target nodes and the files. The first node can query, from the file information table based on the number information of the client carried in the registration request, a node number of the target node corresponding to the client, to determine the second target node. Further, the first node can determine, by querying the file information table based on a node number of the second target node, the second target file required for performing registration by the client.

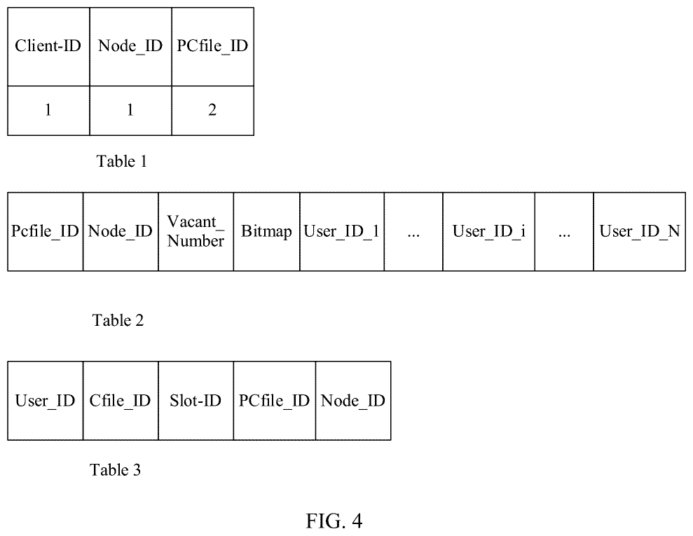

To intuitively describe various types of information stored in the file information table, an embodiment of this application provides a schematic diagram of a file information table. As shown in FIG. 4, the file information table includes Table 1, Table 2, and Table 3. As shown in Table 1 in FIG. 4, content that can be queried from Table 1 is as follows: a client whose client number information (Client-ID) is 1 corresponds to a target node whose node number (Node-ID) is 1 in the second node; and the target node whose node number (Node-ID) is 1 stores a file whose file identifier (PCfile-ID) is 2. Based on this, the second target file required for performing registration by the client whose client number information is 1 is the file whose file identifier is 2 and that is stored in the target node whose node number is 1.

In some embodiments, the file information table includes: a file identifier (PCfile-ID) of a file, a number (Node-ID) of a second node in which the file is located, a bitmap (Bitmap) of the file, and a number of a registered feature in the file. As shown in Table 2 in FIG. 4, a vacant location number of the file is determined based on the bitmap (Bitmap) of the file, and the bitmap indicates an arrangement sequence of vacant location numbers of the file. In some embodiments, the file information table further includes: a total quantity of currently vacant location numbers (vacant-Number) of the file. A vacant location refers to a vacant storage location in the file. Based on this, after determining the second target file based on Table 1 in the file information table, the first node queries Table 2 in the file information table based on number information of the second target node, so that the file information of the second target file may be obtained. The file information includes at least the file identifier and the vacant location number of the file. The first node sends the file information of the second target file to the client, so that the client can process the feature of the object Abased on the vacant location number. After registration is completed, it is ensured that the registered feature corresponding to the object A is stored in a corresponding location in the second target file. In some other embodiments, the first node further sends, to the client, the node number, of the second target node, that is found based on Table 1 above.

In some embodiments, the file information table further includes object information of each registered feature in the file in the second node, and location information of the registered feature in the file. For example, the object information may be a user name of the object, and the location information of the registered feature in the file may be a location number of the registered feature in the file. As shown in Table 3 in FIG. 4, Table 3 includes: a user name (User-ID) of the object, a feature identifier (Cfile-ID) of the registered feature of the object, a file identifier (PCfile-ID) of the file in which the registered feature of the object is located, a location number (slot-ID) of the registered feature of the object in the file, and a node number (Node-ID) of a node in which the registered feature of the object is located.

In some other embodiments, the file information table may further include more file-related information, for example, a storage date of the file and permission to modify the file. This is not limited in this embodiment of this application.

303: The first node sends a registration indication to the second node, where the registration indication carries the number information of the client and the file information of the second target file.

In some embodiments, the first node sends the registration indication to the second node, and sends, to the second node, the node number that is of the target node corresponding to the client and that is found in the file information table, to indicate the second target node, in the second node, that corresponds to the node number to perform subsequent steps.

304: When receiving the file information, of the second target file, that is sent by the first node, the client encodes the feature of the object A, to obtain a first feature vector FA of the object A, where FA is an M-dimensional vector, and M is a positive integer.

The first feature vector FA represents the feature of the object A. For example, FA is a face feature vector that is extracted from a face image of the object A and that can represent the feature of the object A. In this step, the feature of the object A is encoded as a vector of a fixed size, so that efficiency of a subsequent operation process can be improved. In some embodiments, M is a power of 2.

305: The client obtains a second feature vector PA of the object A based on the first feature vector FA of the object A and the file information of the second target file, where PA is N×M-dimensional vectors, and M and N are positive integers.

In some embodiments, the file information of the second target file includes the file identifier of the second target file and the vacant location number of the second target file. The client constructs N×M-dimensional vectors PA based on a received vacant location number X (where the vector PA includes N M-dimensional vector spaces), and encodes the M-dimensional vector FA into an X^{th} M-dimensional vector space in PA, where X is less than or equal to N. Based on this, FA is located in a location corresponding to the vacant location number X in PA, and locations other than the location corresponding to the vacant location number X in PA are all 0 vectors. Both M and N are preset positive integers. In some embodiments, both M and N are powers of 2.

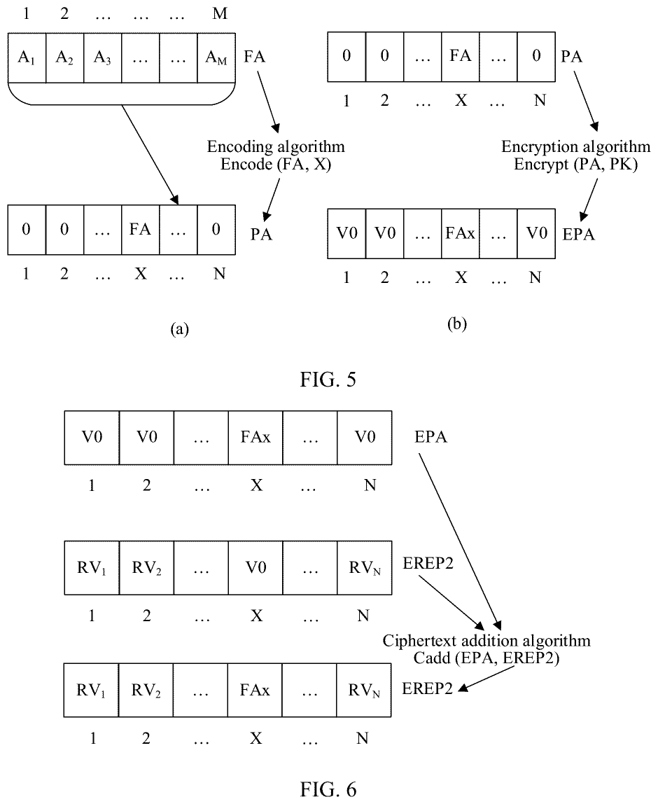

An embodiment of this application provides a schematic diagram of a registration process. FIG. 5 includes (a) and (b). (a) in FIG. 5 is a schematic diagram of a registration encoding process according to an embodiment of this application. (b) in FIG. 5 is a schematic diagram of a registration encryption process according to an embodiment of this application. As shown in (a) in FIG. 5, FA is an M-dimensional first feature vector determined based on the feature of the object A. PA is the second feature vector determined based on an encoding algorithm Encode, and a size is N×M. X is the vacant location number in the second target file.

In some other embodiments, when one client needs to register a plurality of to-be-registered objects, the client may obtain a plurality of vacant location numbers in the second target file, and separately encode first feature vectors of the plurality of to-be-registered objects into a same second feature vector in the foregoing encoding method. This implements algorithm parallelism, and effectively improves information processing efficiency.

According to the foregoing technical solution, based on the file information returned by the first node, the client encodes the feature of the to-be-registered object in the vacant location in the second target file, so that a location of valid information in the to-be-registered encryption feature matches an actual vacant location of the second target file. On a basis of ensuring accuracy of information processing, algorithm parallelism is implemented, and information processing efficiency is effectively improved.

306: The client encrypts the second feature vector PA of the object A based on the public key of the first node, to obtain an encryption feature EPA of the object A.

(b) in FIG. 5 is a schematic diagram of a registration encryption process according to an embodiment of this application. In this embodiment of this application, EPA obtained by encrypting PA based on the public key is N×M-dimensional vectors, and FA obtained after encryption is performed based on the public key is located in an X^{th} M-dimensional ciphertext vector space of EPA, where X is the vacant location number, and ciphertexts, in EPA, other than a location corresponding to the vacant location number X are all ciphertext vectors V0 obtained after the 0 vector is encrypted. As shown in FIG. (b) in FIG. 5, Encrypt is an encryption algorithm, PK is the public key, and FAx is FA obtained after encryption is performed based on the public key.

In some embodiments, PA and the public key PK are used as an input of the encryption algorithm, so that an output, namely, EPA, of the encryption algorithm is obtained. The encryption algorithm may be in a form of a polynomial. To ensure that the second node can perform a homomorphic operation based on the evaluation key, conditions that a quantity of times of the polynomial needs to meet include: (1) The quantity of times of the polynomial is a power of 2; (2) the quantity of times of the polynomial is much greater than a feature dimension M; and (3) the quantity of times of the polynomial is a multiple of M.

According to the foregoing technical solution, the feature of the object is encrypted on a client side, to ensure that a plaintext of user information does not appear in a device other than the client. This effectively ensures information security.

307: The client sends EPA and the number information of the client to the second node.

In some embodiments, the client sends the node number obtained from the first node to the second node, to indicate the second target node in the second node to perform registration based on EPA.

308: In response to the registration indication, the scheduling node in the second node sends the registration indication and EPA to the second target node in the second node based on the file information of the second target file when the number information received from the client is consistent with the number information of the client carried in the registration indication.

In some embodiments, the second node compares whether the number information of the client received from the first node is consistent with the number information of the client received from the client, to ensure that the file information carried in the registration indication this time is file information required for registering the object A. The second node effectively ensures information security by performing consistency verification on the number information from the two different sources.

In some embodiments, the file information of the second target file includes the file identifier of the second target file, the node number of the node in which the second target file is located, and the vacant location number of the second target file. In response to the registration indication, the scheduling node in the second node sends the registration indication and EPA that is received from the client to the second target node corresponding to the node number when determining that the registration indication this time is consistent with that of the client.

In some other embodiments, the scheduling node in the second node receives the node number sent by the first node and the node number sent by the client; and before sending the registration indication and EPA that is received from the client to the second target node, the scheduling node compares whether the node numbers from the two different sources are consistent, to further ensure information security.

According to the foregoing technical solution, the scheduling node in the second node can schedule the plurality of target nodes in parallel based on an indication of the first node, perform information registration for the client, and implement a physical parallel operation by using a correspondence between the target node and a number of the client, so that information processing efficiency is greatly improved.

309: The second target node in the second node adds the received encryption feature EPA of the object A to the second target file.

The second target file includes the plurality of registered features, and the plurality of registered features are all ciphertexts encrypted based on the public key. Therefore, the second target node adds the encryption feature encrypted based on the public key to the second target file in a ciphertext state. For example, the second target node adds the encryption feature encrypted based on the public key to the second target file, to obtain an updated second target file. Because parts of a newly registered encryption feature other than the vacant location are all 0, another registered feature in the second target file is not affected, so that a purpose of storing a plurality of features in a file in parallel is achieved.

In some embodiments, EPA is N×M-dimensional vectors, and FA encrypted based on the public key is located in an X^{th} M-dimensional ciphertext vector space of EPA. The second target file is N×M-dimensional vectors EREP2, and N registered features in the second target file are all in a form of an M-dimensional vector, and are respectively located in N M-dimensional ciphertext vector spaces. X is a vacant location number of EREP2. To be specific, an X^{th} M-dimensional ciphertext vector space of EREP2 may be used to store the new registered feature. EPA and EREP2 are added in the ciphertext vector space, so that encrypted FA may be stored in the X^{th} M-dimensional ciphertext vector space of EREP2. Based on this, the second node stores EPA and EREP2 to which EPA is added. In this case, EREP2 includes the registered feature of the object A. It may be understood that ciphertexts in EPA other than the X^{th} M-dimensional ciphertext vector space are all encrypted 0 vectors. Therefore, in an addition process, a registered feature other than the vacant location in EREP2 is not affected.

To intuitively describe the foregoing addition process, an embodiment of this application provides a schematic diagram of a registration process. As shown in FIG. 6, EPA is the encryption feature of the object A, and a size is N×M. EREP2 is the second target file, has a size of N×M, and includes N registered features RV CAdd is a ciphertext addition algorithm.

310: The second node sends addition success information to the first node.

In some embodiments, the second target node in the second node returns the addition success information to the scheduling node in the second node, and the scheduling node sends the addition success information to the first node.

311: When receiving the addition success information, the first node adds the object information of the object A to the file information table, where the file information table includes the object information of each registered feature in the file in the second node and the location information of each registered feature in the file in the second node.

When the second node has stored the registered feature of the object A, the first node adds the object information of the object A and the location information of the registered feature of the object A in the second target file to the file information table. In some embodiments, the location information includes the location number of the registered feature of the object A in the second target file. In some embodiments, the first node adds the object information of the object A to the file information table. For example, in Table 2 in FIG. 4, the first node writes the user name of the object A at the location corresponding to the vacant location number X in Table 2 that corresponds to the second target file. Anew column is added to Table 3 in FIG. 4, and is used to record the user name of the object A, the feature identifier of the registered feature of the object A, the file identifier of the second target file in which the registered feature of the object A is located, the location number of the registered feature of the object Ain the second target file, and the number of the node in which the registered feature of the object A is located.

312: The first node sends registration success information to the client.

According to the foregoing technical solution, the first node stores the private key and public object information, and the second node stores information obtained by encryption based on the public key of the first node. This ensures separation of storage permission and decryption permission. When feature information of an object is not sent out from the client, a plurality of nodes interact with each other based on an information mapping relationship. This may implement efficient information processing and effectively ensure information security.

Further, in a process of performing information registration, registration encoding is used to ensure that registration is performed based on a vacant location in the second target file corresponding to the to-be-registered object, and the registration process does not affect another registered feature. This implements dynamic registration in an encrypted state, improves flexibility of information processing, and improves information processing efficiency on a basis of ensuring information security.

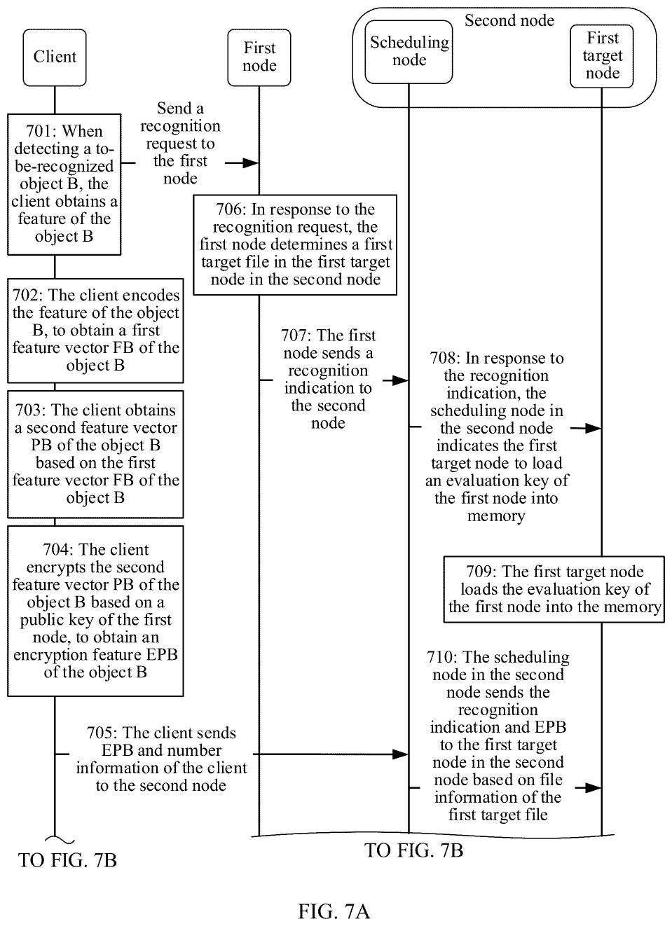

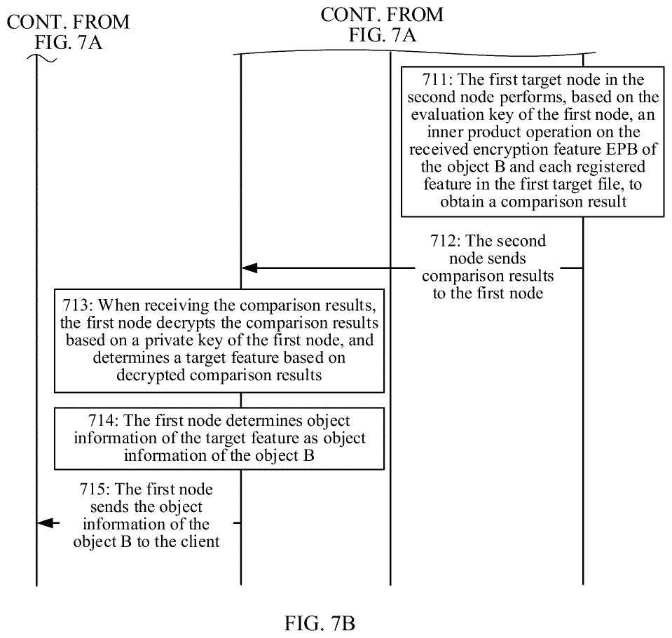

After the information registration process in the information processing method provided in embodiments of this application is described, the following describes an information recognition process in the information processing method provided in embodiments of this application. FIG. 7A and FIG. 7B are a schematic flowchart of an information processing method according to an embodiment of this application. As shown in FIG. 7A and FIG. 7B, the method includes the following steps.

701: When detecting a to-be-recognized object B, a client sends a recognition request to a first node, to obtain a feature of the object B, where the recognition request carries number information of the client.

For this step, refer to step 301. For example, in a facial recognition-based scenario, the client detects a face, triggers a face-based recognition request, sends the recognition request to the first node, and processes the detected face, to obtain a facial feature.

702: The client encodes the feature of the object B, to obtain a first feature vector FB of the object B, where FB is an M-dimensional vector, and M is a positive integer.

For this step, refer to step 304. Details are not described herein. In some embodiments, M is a power of 2.

It should be noted that, in step 701, the step of sending the recognition request to the first node and the step of obtaining the feature of the object B may be simultaneously performed or may be sequentially performed. This is not limited in this embodiment of this application.

703: The client obtains a second feature vector PB of the object B based on the first feature vector FB of the object B, where PB is N×M-dimensional vectors, and M and N are positive integers.

In some embodiments, the client constructs N×M-dimensional vectors PB (where the vector PB includes N M-dimensional vector spaces), and encodes an M-dimensional vector FB into each M-dimensional vector space in PB. Based on this, PB includes N vectors FB, and both M and N are preset positive integers. In some embodiments, both M and N are powers of 2.

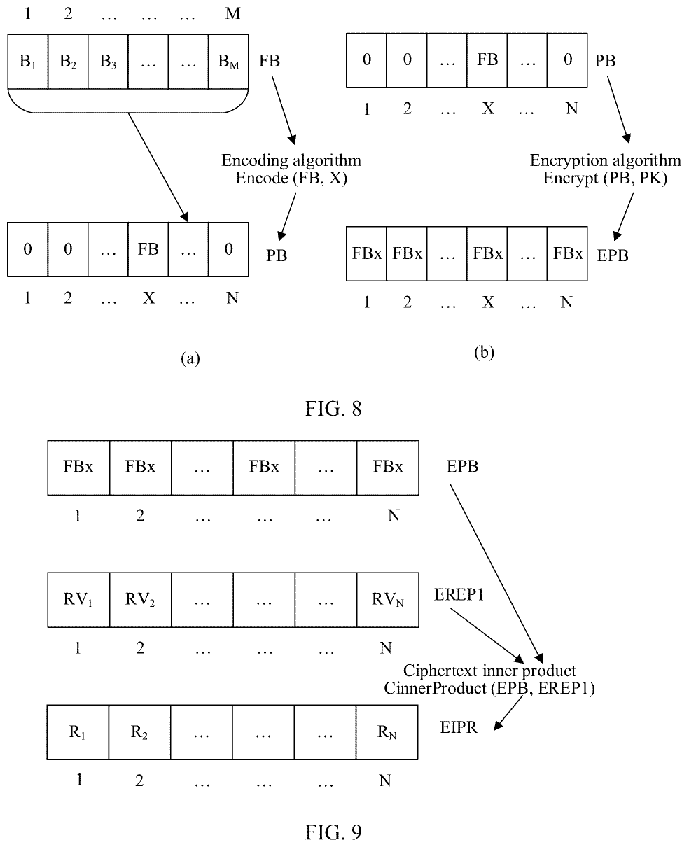

An embodiment of this application provides a schematic diagram of a recognition process. FIG. 8 includes (a) and (b). (a) in FIG. 8 is a schematic diagram of a recognition encoding process according to an embodiment of this application. (b) in FIG. 8 is a schematic diagram of a recognition encryption process according to an embodiment of this application. As shown in (a) in FIG. 8, FB is an M-dimensional first feature vector determined based on the feature of the object B. PB is a second feature vector determined based on an encoding algorithm Encode, and a size is N×M.

704: The client encrypts the second feature vector PB of the object B based on a public key of the first node, to obtain an encryption feature EPB of the object B.

For this step, refer to step 306. Details are not described herein.

(b) in FIG. 8 is a schematic diagram of a recognition encryption process according to an embodiment of this application. Encrypt is an encryption algorithm, PK is the public key, EPB obtained by encrypting PB based on the public key is N×M-dimensional vectors, and FBx is FB encrypted based on the public key.

705: The client sends EPB and the number information of the client to a second node.

706: In response to the recognition request, the first node determines a first target file in a first target node in the second node.

In this step, the first node queries, based on the number information of the client in the recognition request, a file information table stored in the first node, to determine the first target file. For a principle, refer to step 302. Details are not described herein.

It may be understood that, in some embodiments, because registered objects corresponding to files in a plurality of target nodes included in the second node are different, the first target node that corresponds to the client and that is in the second node needs to be determined based on the number information of the client, and then the first target node is used, so that the first target file required for performing recognition based on the client can be obtained. For example, in a facial recognition-based scenario, when recognition is performed by the client, after receiving the recognition request of the client, the first node determines, based on department information carried in the recognition request, the first target node corresponding to the department, to perform recognition in a registered face file of the department.

707: The first node sends a recognition indication to the second node, where the recognition indication carries the number information of the client and file information of the first target file.

For this step, refer to step 303. Details are not described herein.

708: In response to the recognition indication, a scheduling node in the second node indicates the first target node to load an evaluation key of the first node into memory.

Each target node in the second node stores the evaluation key of the first node. Because a data volume of the evaluation key is usually large, the node loads the evaluation key to the memory when using the evaluation key, to prevent the evaluation key from occupying running memory in another case. In some embodiments, in response to the recognition indication received from the first node, the scheduling node in the second node indicates, based on a node number included in the file information in the recognition indication, the first target node corresponding to the node number to load the evaluation key of the first node into the memory. Based on this, when receiving the recognition indication, the first target node directly loads the evaluation key, so that when receiving the encryption feature sent by the client, the first target node may directly perform recognition based on the evaluation key in the memory. This reduces time for loading the evaluation key in a recognition process.

According to the foregoing technical solution, a physical data parallel processing capability of a multi-node architecture of the information processing system is fully utilized, and information processing efficiency is greatly improved.

709: The first target node loads the evaluation key of the first node into the memory.

In some embodiments, the foregoing scheduling node can indicate, by sending notification information to the first target node, the first target node to perform loading. Correspondingly, in response to receiving the notification information, the first target node loads the evaluation key of the first node into the memory.

710: The scheduling node in the second node sends the recognition indication and EPB to the first target node in the second node based on the file information of the first target file when the number information received from the client is consistent with the number information of the client carried in the recognition indication.

For this step, refer to step 308. Details are not described herein.

According to the foregoing technical solution, the scheduling node in the second node can schedule the plurality of target nodes in parallel based on an indication of the first node, recognize the client, and implement a physical parallel operation by using a correspondence between the target node and a number of the client, so that real-time information recognition is ensured while information processing efficiency is improved.

711: The first target node in the second node performs, based on the evaluation key of the first node, an inner product operation on the received encryption feature EPB of the object B and each registered feature in the first target file, to obtain a comparison result.

For a principle of this step, refer to step 309. Details are not described herein.

The evaluation key, of the first node, that is used in this step is preloaded into the memory in step 709. In some embodiments, the first target node does not preload the evaluation key of the first node, but starts to load the evaluation key of the first node after receiving EPB of the client and the recognition indication.

In some embodiments, EPB is N×M-dimensional vectors, and FB encrypted based on the public key is located in each M-dimensional ciphertext vector space of EPB. The first target file is N×M-dimensional vectors EREP1, and N registered features in the first target file are all in a form of an M-dimensional vector, and are respectively located in N M-dimensional ciphertext vector spaces. The second node performs a ciphertext inner product operation on EPB and EREP1 in the ciphertext vector space based on the evaluation key, to obtain the comparison result EIPR. It may be understood that each M-dimensional ciphertext vector space in EPB stores FB encrypted based on the public key. Therefore, based on the inner product operation, results of performing inner product operations between the N registered features in EREP1 and encrypted FB separately can be obtained in parallel. The inner product operation essentially compares a similarity between vectors. Therefore, EIPR includes similarities, in N encrypted states, that are obtained by separately comparing the N registered features with encrypted FB.

To intuitively describe a process of obtaining the comparison result, an embodiment of this application provides a schematic diagram of a recognition process. As shown in FIG. 9, EPB is the encryption feature of the object B, and is N×M-dimensional vectors. EREP1 is the first target file, and is N×M-dimensional vectors. CinnerProduct is a ciphertext inner product algorithm. EIPR is the comparison result, and is N×M-dimensional vectors.

It may be understood that the ciphertext inner product operation in this embodiment of this application is a multi-dimensional vector multiplication process. In some embodiments, expansion, of a number of dimensions of a ciphertext vector, caused by vector multiplication is controlled based on the evaluation key, and after ciphertext calculation is performed, key switching is performed, so that an expanded number of feature dimensions of the ciphertext is restored to an original number of feature dimensions of the ciphertext, to reduce an error caused by calculation in the ciphertext state, and improve accuracy of information processing, for example, a hierarchical fully homomorphic CKKS algorithm and a hierarchical fully homomorphic BFV algorithm.

In some embodiments, the inner product operation is calculating a Euclidean distance. In some other embodiments, the inner product operation is calculating a cosine distance. This is not limited in this embodiment of this application.

In some other embodiments, there are a plurality of first target nodes related to the information recognition process. In this case, the second node can schedule the plurality of first target nodes to perform operations based on the first target files respectively stored by the plurality of first target nodes and based on the received encryption feature EPB of the object B in parallel, and obtain a plurality of comparison results determined by the plurality of first target nodes.

712: The second node sends the comparison results to the first node.

In some embodiments, the first target nodes in the second node return the comparison results to the scheduling node in the second node, and the scheduling node sends the plurality of received comparison results to the first node.

713: When receiving the comparison results, the first node decrypts the comparison results based on the private key of the first node, and determines a target feature based on decrypted comparison results, where the target feature is a registered feature with a maximum similarity to the feature of the object B.

In this embodiment of this application, the first node holds the private key. According to a homomorphic encryption principle, a result obtained after the comparison results are decrypted is equivalent to a similarity between the feature of the object B and a feature of each registered object in an unencrypted state. It may be understood that, in a plurality of similarities obtained after decryption, a registered object corresponding to a similarity with a maximum value may be considered as a same object as the object B.

In some embodiments, the decrypted comparison results are N M-dimensional result vectors R. As shown in FIG. 9, a value in a target dimension in each result vector R indicates a similarity of a registered feature corresponding to the value. For example, the comparison results are N 128-dimensional result vectors R, and a value of the first dimension of each R is the similarity. Based on this, the first node obtains, from the decrypted comparison results, a number of the result vector with the similarity whose value is maximum, and determines a registered feature corresponding to the number in the first target file as the target feature.

In some embodiments, a similarity threshold is set. After a maximum similarity is determined, when the similarity is greater than the similarity threshold, a registered feature corresponding to the similarity is determined as the target feature, to further ensure accuracy of the comparison results.

714: The first node obtains the object information of the target feature from the file information table based on the location information of the target feature in the first target file, and determines the object information of the target feature as the object information of the object B, where the file information table includes object information of each registered feature in the file in the second node and location information of each registered feature in the file in the second node.

In this embodiment of this application, for the file information table, refer to descriptions in step 302. Details are not described herein.

In some embodiments, the location information of the target feature in the first target file includes a location number of the target feature in the first target file. The first node may obtain the object information of the target feature from the file information table based on a file identifier of the first target file and the location number of the target feature. For example, the object information may be a user name of a registered object corresponding to the target feature. Based on this, the object information of the object B is determined. Optionally, the object information includes identity information, for example, a name, an age, and an identity card number, of the registered object corresponding to the target feature. This is not limited in this embodiment of this application.

715: The first node sends the object information of the object B to the client.

According to the foregoing technical solution, the first node stores the private key and public object information, and the second node stores information obtained by encryption based on the public key of the first node. This ensures separation of storage permission and decryption permission. When feature information of an object is not sent out from the client, a plurality of nodes interact with each other based on an information mapping relationship. This may implement efficient information processing and effectively ensure information security.

In addition, according to the foregoing technical solution, one-to-many information recognition may be implemented based on a set of keys. This effectively resolves a problem that a large quantity of storage spaces are occupied to store a plurality of sets of keys corresponding to a plurality of registered features.

Further, in the foregoing technical solution, in a process of performing information recognition, a feature of a to-be-recognized object is encoded as a multi-dimensional vector that matches a dimension of the first target file, so that the feature of the to-be-recognized object can be compared with a plurality of registered objects in parallel. This is equivalent to completing an information processing process for the plurality of registered objects in one processing periodicity, so that information processing efficiency is greatly improved.

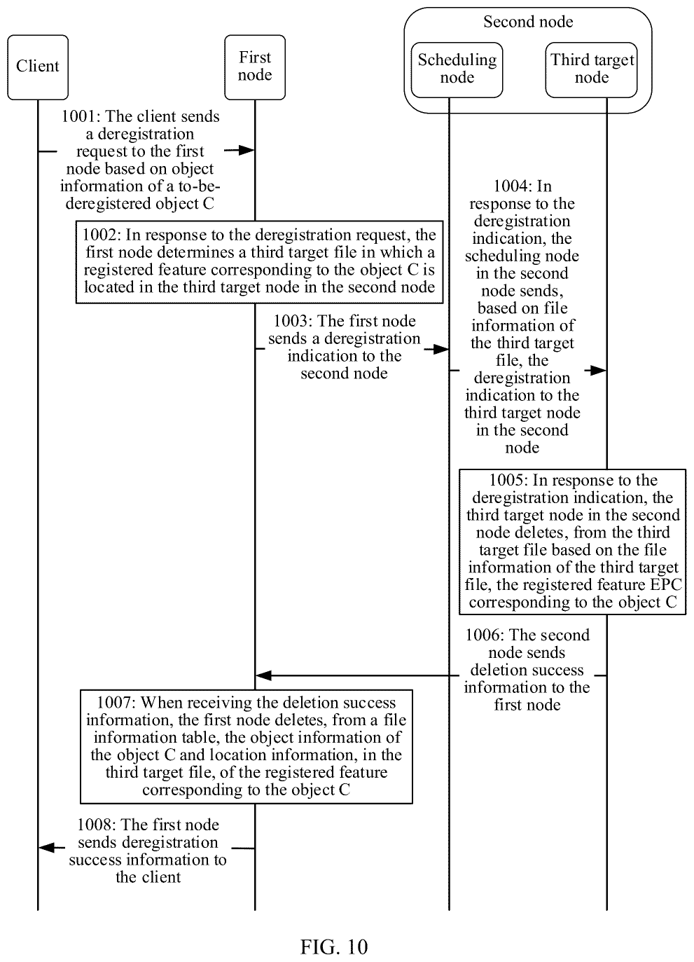

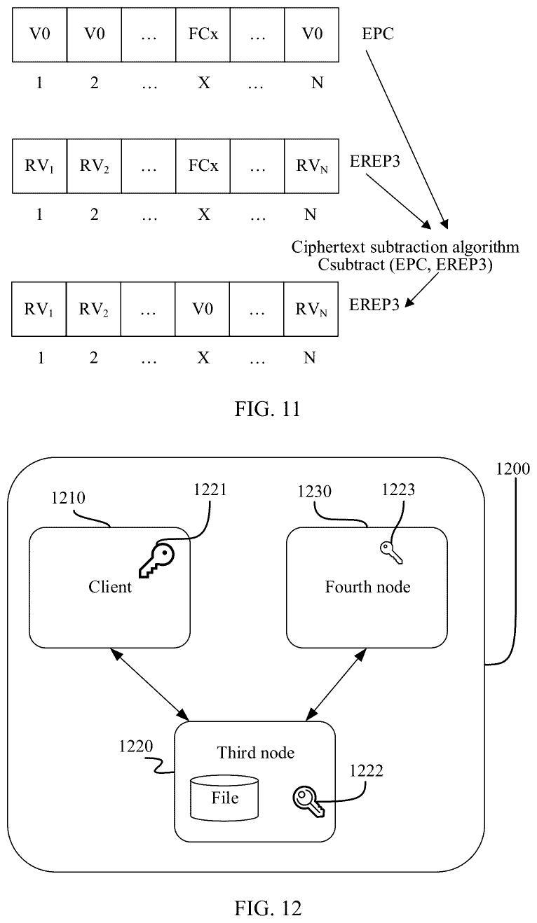

The following describes an information deregistration process in the information processing method provided in embodiments of this application. FIG. 10 is a schematic flowchart of an information processing method according to an embodiment of this application. As shown in FIG. 10, the method includes the following steps.

1001: A client sends a deregistration request to a first node based on object information of a to-be-deregistered object C, where the deregistration request carries number information of the client and the object information of the to-be-deregistered object C.

For this step, refer to step 301. Details are not described herein.

1002: In response to the deregistration request, the first node determines a third target file in which a registered feature corresponding to the object C is located in a third target node in the second node.

In this embodiment of this application, the object C is a registered and to-be-deregistered object. Therefore, a file information table stores the object information of the object C and location information, in a file in the second node, of the registered feature corresponding to the object C.

In some embodiments, in response to the deregistration request, the first node may determine the third target node by querying the file information table based on the information number of the client carried in a to-be-registered request. The third target file in which the registered feature corresponding to the object C is located may be directly determined by querying the file information table based on the object information of the object C. For a principle of this step, refer to step 302. Details are not described herein.

1003: The first node sends a deregistration indication to the second node, where the deregistration indication carries the number information of the client and file information of the third target file.

For this step, refer to step 303. Details are not described herein.

1004: In response to the deregistration indication, when the number information received from the client is consistent with the number information of the client carried in the deregistration indication, a scheduling node in the second node sends, based on the file information of the third target file, the deregistration indication to the third target node in the second node.

For this step, refer to step 308. Details are not described herein.

1005: In response to the deregistration indication, the third target node in the second node deletes, from the third target file based on the file information of the third target file, the registered feature EPC corresponding to the object C.

In some embodiments, in a process of performing information registration on the object C, the registered feature EPC of the object C is stored (refer to the process of adding EPA in step 309). Therefore, the second node obtains EREP3 and EPC based on the file information of the third target file, a file identifier of the third target file EREP3, and a feature identifier of the registered feature EPC of the object C, subtracts EPC and EREP3 from a ciphertext vector space, and stores EREP3 after EPC is deleted. For a principle of this step, refer to step 309. Details are not described herein.

To intuitively describe the foregoing deletion process, an embodiment of this application provides a schematic diagram of a deregistration process. As shown in FIG. 11, EPC is the registered feature of the object C, and a size is N×M. FCx is obtained through encryption by performing registration encoding based on the feature of the object C in the registration process of the object C (refer to step 304 to step 306). EREP3 is the third target file, and a size is N×M. X is a location number of the registered feature of the object C in EREP3. Csubtract is a ciphertext subtraction algorithm.

1006: The second node sends deletion success information to the first node.

For this step, refer to step 310. Details are not described herein.

1007: When receiving the deletion success information, the first node deletes, from the file information table, the object information of the object C and the location information, in the third target file, of the registered feature corresponding to the object C, where the file information table includes object information of each registered feature in the file in the second node and location information of each registered feature in the file in the second node.

When the second node has deleted the registered feature of the object C, the first node deletes, from the file information table, the object information of the object C and the location information of the registered feature of the object C in the second target file. This step is similar to step 311. Details are not described herein.

1008: The first node sends deregistration success information to the client.

According to the foregoing technical solution, the first node stores a private key and public object information, and the second node stores information encrypted based on a public key of the first node. This ensures separation of storage permission and decryption permission. When feature information of an object is not sent out from the client, a plurality of nodes interact with each other based on an information mapping relationship. This may implement efficient information processing and effectively ensure information security.

Further, in a process of performing information deregistration, based on the information mapping relationship stored in the file information table, it is ensured that deregistration is performed on the registered feature of the to-be-deregistered object, and the deregistration process does not affect another registered feature. This implements dynamic deregistration in an encrypted state, improves flexibility of information processing, and improves information processing efficiency on a basis of ensuring information security.

An embodiment of this application provides another information processing system. FIG. 12 is a schematic diagram of an architecture of an information processing system according to an embodiment of this application. The information processing system 1200 includes a client 1210, a third node 1220, and a fourth node 1230.

The client 1210 is configured to: when detecting a to-be-recognized object, obtain a feature of the to-be-recognized object, encrypt the obtained feature of the to-be-recognized object based on a public key 1221 of the third node 1220, to obtain an encryption feature, and send the encryption feature and a recognition request to the third node 1220, to indicate the third node to recognize the client 1210.

The third node 1220 is configured to store a file information table and a file in which a registered feature is located. The third node 1220 is configured to: in response to the recognition request of the client, compare, based on the file information table, an evaluation key 1222 of the third node 1220, and the stored file, the encryption feature received from the client, to obtain a comparison result, and send the comparison result to the fourth node 1230.

The fourth node 1230 is configured to decrypt the received comparison result based on a private key 1223 of the third node 1220, and send the decrypted comparison result to the third node 1220.

The third node 1220 is further configured to determine object information (for example, identity information) of the to-be-recognized object based on the decrypted comparison result, and send the object information to the client 1210.

The client 1210, the third node 1220, and the fourth node 1230 are communicatively connected through a wired network or a wireless network. In some embodiments, the foregoing wireless network or wired network uses a standard communication technology and/or protocol. The network is usually the internet, but can also be any network including, but not limited to, a local area network (local area network, LAN), a metropolitan area network (metropolitan area network, MAN), a wide area network (wide area network, WAN), or any combination of a mobile, wired, or wireless network, a private network, or a virtual private network. In some embodiments, peer-to-peer (peer-to-peer, P2P) communication is implemented between the client 1210, the third node 1220, and the fourth node 1230 based on a remote procedure call protocol (remote procedure call protocol, RPC). In some embodiment, the client 1210, the third node 1220, and the fourth node 1230 use a technology and/or a format including the hyper text markup language (hyper text markup language, HTML), the extensible markup language (extensible markup language, XML), and the like to represent data exchanged through a network. In addition, the client 1210, the third node 1220, and the fourth node 1230 can also use conventional encryption technologies of the secure socket layer (secure socket layer, SSL), the transport layer security (transport layer security, TLS), the virtual private network (virtual private network, VPN), the internet protocol security (internet protocol security, IPsec), and the like, to encrypt all or some links. In some other embodiments, custom and/or dedicated data communication technologies can also be used to place or supplement the data communication technologies described above.

In some embodiments, the client is a terminal or a server on a user side. The terminal is also referred to as an intelligent terminal or a mobile intelligent terminal, and refers to a type of device that has rich human-computer interaction manners, has an internet access capability, usually carries various operating systems, and has a strong processing capability. In some embodiments, a type of the mobile intelligent terminal includes but is not limited to a smartphone, a tablet computer, a vehicle-mounted terminal, a handheld game console, and the like. The server may be a server cluster including one or more computing devices.

In some embodiments, the third node and the fourth node may be independent physical servers, or may be server clusters or distributed systems including a plurality of physical servers, or may be cloud servers that provide basic cloud computing services of cloud services, cloud databases, cloud computing, cloud functions, cloud storage, network services, cloud communication, middleware services, domain name services, security services, content delivery networks (content delivery networks, CDNs), big data, artificial intelligence platforms, and the like.

In FIG. 12, an architecture of another information processing system provided in this embodiment of this application is described from a perspective of a system architecture. The following describes hardware structures of a client, a third node, and a fourth node in the information processing system.

In FIG. 2, a computing device is provided. The computing device can be configured as any one of the client, the second node, or the third node in the information processing system 1200. Refer to FIG. 2. Details are not described herein.

The following describes an information processing method provided in this embodiment of this application. The method can be applied to the foregoing information processing system 1200.

In this embodiment of this application, before information processing is performed based on the information processing system, a group including a public key, a key, and an evaluation key that are deployed in the information processing system need to be determined based on a processing requirement parameter in the system by using a key generation algorithm. For a principle, refer to the information processing system corresponding to FIG. 1. Details are not described herein. In this embodiment of this application, a process of determining the group including the public key, the key, and the evaluation key by using the key generation algorithm is performed by the third node. The third node configures the public key for the client. The public key is used to encrypt an obtained feature of an object; and send a private key to the fourth node. The private key is used to decrypt encrypted information, where the private key is held only by the fourth node, to be specific, only the fourth node can decrypt the encrypted information in the information processing system. In some embodiments, the fourth node stores the private key in secure hardware, for example, a trusted execution environment (trusted execution environment, TEE), to ensure security of the private key.

The evaluation key is used to perform a homomorphic operation on the encrypted feature (ciphertext). In some embodiments, the third node can configure the public key and the evaluation key for any node in the information processing system. This is not limited in this embodiment of this application.

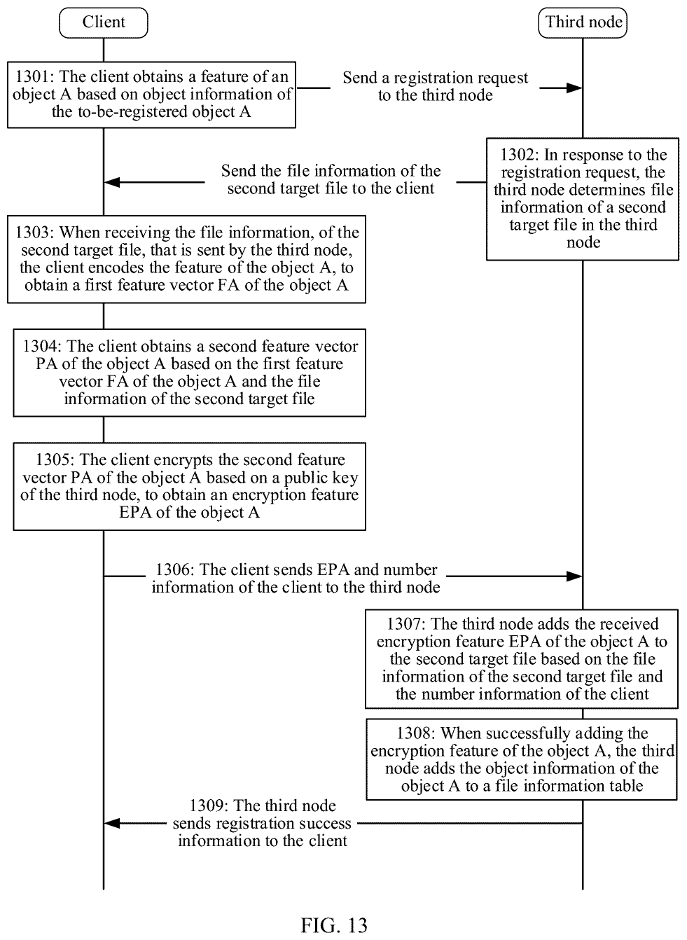

In embodiments of this application, when parameters of the public key, the private key, the evaluation key, and the like have been deployed in the information processing system, the information processing method provided in embodiments of this application may be implemented based on the information processing system. The following describes a process of performing information registration on a to-be-registered object in the information processing method provided in embodiments of this application. FIG. 13 is a schematic flowchart of an information processing method according to an embodiment of this application. As shown in FIG. 13, the method includes the following steps.

1301: A client sends a registration request to a third node based on object information of a to-be-registered object A, to obtain a feature of the object A, where the registration request carries number information of the client and the object information of the object A.

For this step, refer to step 301. Details are not described herein.

1302: In response to the registration request, the third node determines file information of a second target file in the third node, and sends the file information of the second target file to the client.

For this step, refer to step 302. Details are not described herein.

1303: When receiving the file information, of the second target file, that is sent by the third node, the client encodes the feature of the object A, to obtain a first feature vector FA of the object A, where FA is an M-dimensional vector, and M is a positive integer.

For this step, refer to step 304. Details are not described herein.

1304: The client obtains a second feature vector PA of the object A based on the first feature vector FA of the object A and the file information of the second target file, where PA is N×M-dimensional vectors, and M and N are positive integers.

For this step, refer to step 305. Details are not described herein.

1305: The client encrypts the second feature vector PA of the object A based on a public key of the third node, to obtain an encryption feature EPA of the object A.

For this step, refer to step 306. Details are not described herein.

1306: The client sends EPA and the number information of the client to the third node.

1307: The third node adds the received encryption feature EPA of the object A to the second target file based on the file information of the second target file and the number information of the client.

For this step, refer to step 309. Details are not described herein.

1308: When successfully adding the encryption feature of the object A, the third node adds the object information of the object A to a file information table, where the file information table includes object information of each registered feature in a file in the third node and location information of each registered feature in the file in the third node.

For this step, refer to step 311. Details are not described herein.

1309: The third node sends registration success information to the client.

According to the foregoing technical solution, the third node stores information encrypted based on the public key and public object information, and a fourth node stores a private key. This ensures separation of storage permission and decryption permission. When feature information of an object is not sent out from the client, a plurality of nodes interact with each other based on an information mapping relationship. This may implement efficient information processing and effectively ensure information security. Further, the fourth node is only used to provide a decryption service. A process of information exchange between the plurality of nodes is simplified, and information processing efficiency is effectively improved.

In the foregoing technical solution, in a process of performing information registration, registration encoding is used to ensure that registration is performed based on a vacant location in the second target file corresponding to the to-be-registered object, and the registration process does not affect another registered feature. This implements dynamic registration in an encrypted state, improves flexibility of information processing, and improves information processing efficiency on a basis of ensuring information security.

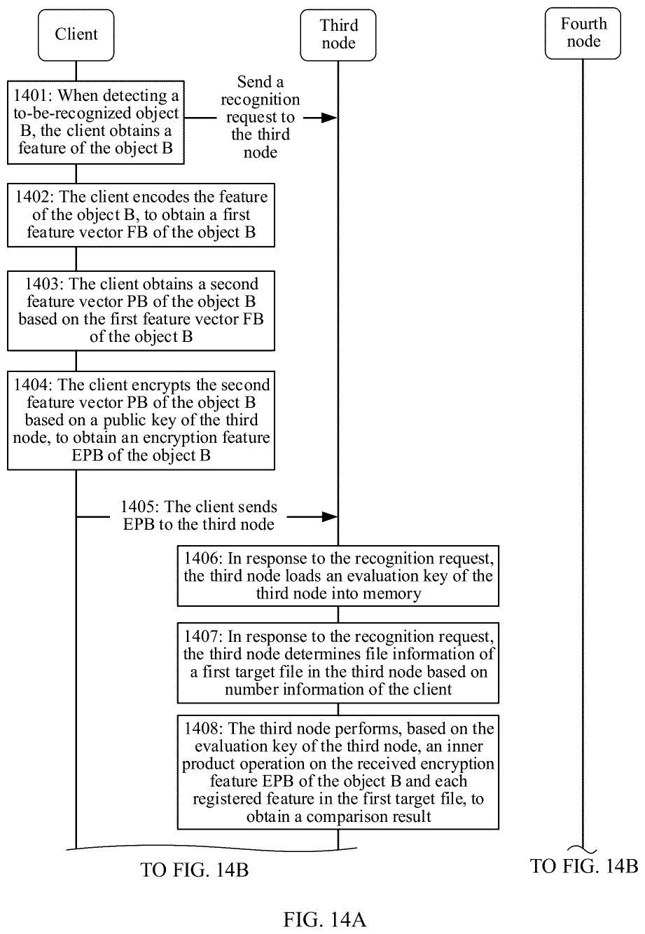

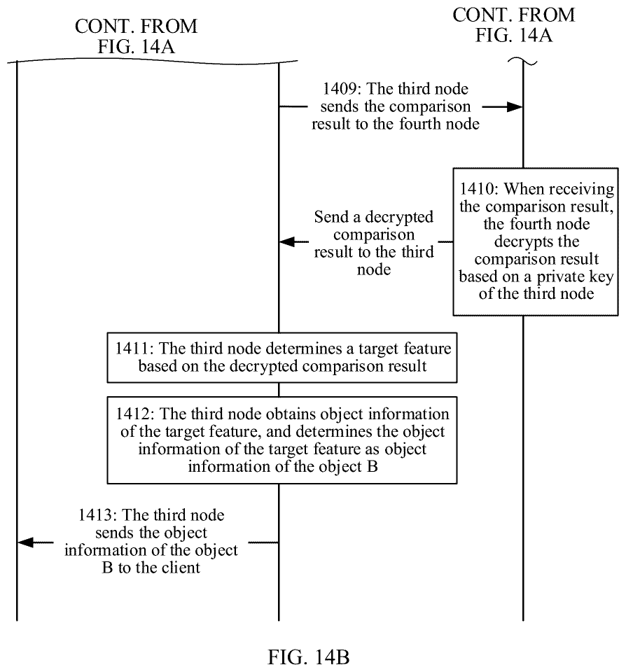

After the information registration process in the information processing method provided in embodiments of this application is described, the following describes an information recognition process in the information processing method provided in embodiments of this application. FIG. 14A and FIG. 14B are a schematic flowchart of an information processing method according to an embodiment of this application. As shown in FIG. 14A and FIG. 14B, the method includes the following steps.

1401: When detecting a to-be-recognized object B, a client sends a recognition request to a third node, to extract a feature of the object B, where the recognition request carries number information of the client.

For this step, refer to step 701. Details are not described herein.

1402: The client encodes the feature of the object B, to obtain a first feature vector FB of the object B, where FB is an M-dimensional vector, and M is a positive integer.

For this step, refer to step 702. Details are not described herein.

1403: The client obtains a second feature vector PB of the object B based on the first feature vector FB of the object B, where PB is N×M-dimensional vectors, and M and N are positive integers.

For this step, refer to step 703. Details are not described herein.

1404: The client encrypts the second feature vector PB of the object B based on a public key of the third node, to obtain an encryption feature EPB of the object B.

For this step, refer to step 704. Details are not described herein.

1405: The client sends EPB to the third node.

1406: In response to the recognition request, the third node loads an evaluation key of the third node into memory.

For this step, refer to step 708 and step 709. Details are not described herein.

1407: In response to the recognition request, the third node determines file information of a first target file in the third node based on the number information of the client.

For this step, refer to step 706. Details are not described herein.

It should be noted that, step 1406 and step 1407 may be simultaneously performed or may be sequentially performed. This is not limited in this embodiment of this application.

1408: The third node performs, based on the evaluation key of the third node, an inner product operation on the received encryption feature EPB of the object B and each registered feature in the first target file, to obtain a comparison result.

For a principle of this step, refer to step 711. Details are not described herein.

1409: The third node sends the comparison result to a fourth node.

1410: When receiving the comparison result, the fourth node decrypts the comparison result based on a private key of the third node, and sends a decrypted comparison result to the third node.

For a principle of this step, refer to step 713. Details are not described herein.

1411: The third node determines a target feature based on the decrypted comparison result, where the target feature is a registered feature with a maximum similarity to the feature of the object B.

For a principle of this step, refer to step 713. Details are not described herein.

1412: The third node obtains object information of the target feature from a file information table based on location information of the target feature in the first target file, and determines the object information of the target feature as object information of the object B, where the file information table includes object information of each registered feature in a file in the third node and location information of each registered feature in the file in the third node.

For a principle of this step, refer to step 714. Details are not described herein.

1413: The third node sends the object information of the object B to the client.

According to the foregoing technical solution, the third node stores information encrypted based on the public key and public object information, and the fourth node stores the private key. This ensures separation of storage permission and decryption permission. When feature information of an object is not sent out from the client, a plurality of nodes interact with each other based on an information mapping relationship. This may implement efficient information processing and effectively ensure information security. Further, the fourth node is only used to provide a decryption service. A process of information exchange between the plurality of nodes is simplified, and information processing efficiency is effectively improved.

In addition, according to the foregoing technical solution, one-to-many information recognition may be implemented based on a set of keys. This effectively resolves a problem that a large quantity of storage spaces are occupied to store a plurality of sets of keys corresponding to a plurality of registered features.

In the foregoing technical solution, in a process of performing information recognition, a feature of a to-be-recognized object is encoded as a multi-dimensional vector that matches a dimension of the first target file, so that the feature of the to-be-recognized object can be compared with a plurality of registered objects in parallel. This is equivalent to completing an information processing process for the plurality of registered objects in one processing periodicity, so that information processing efficiency is greatly improved.

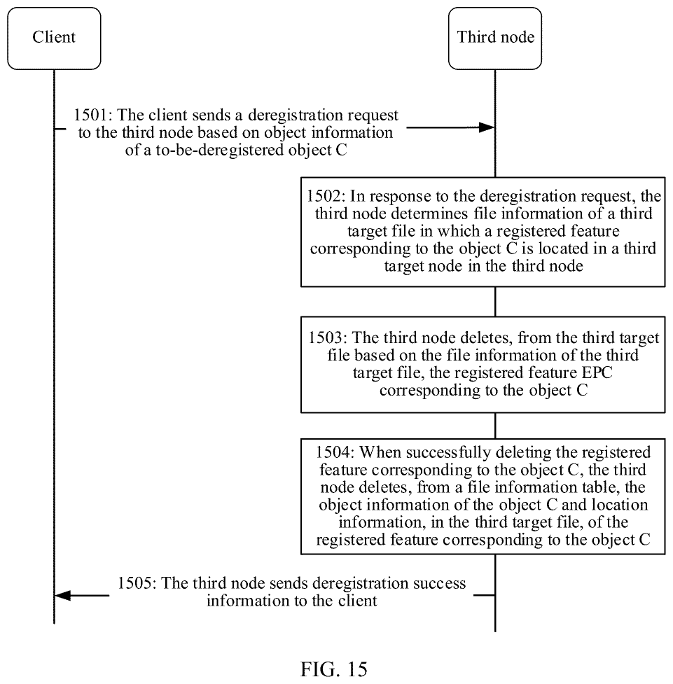

The following describes an information deregistration process in the information processing method provided in embodiments of this application. FIG. 15 is a schematic flowchart of an information processing method according to an embodiment of this application. As shown in FIG. 15, the method includes the following steps.

1501: A client sends a deregistration request to a third node based on object information of a to-be-deregistered object C, where the deregistration request carries number information of the client and the object information of the to-be-deregistered object C.

For this step, refer to step 1001. Details are not described herein.

1502: In response to the deregistration request, the third node determines file information of a third target file in which a registered feature corresponding to the object C is located in a third target node in the third node.

For this step, refer to step 1002. Details are not described herein.

1503: The third node deletes, from the third target file based on the file information of the third target file, the registered feature EPC corresponding to the object C.

For this step, refer to step 1005. Details are not described herein.

1504: When successfully deleting the registered feature corresponding to the object C, the third node deletes, from a file information table, the object information of the object C and location information, in the third target file, of the registered feature corresponding to the object C, where the file information table includes object information of each registered feature in a file in the third node and location information of each registered feature in the file in the third node.

For this step, refer to step 1007. Details are not described herein.

1505: The third node sends deregistration success information to the client.

According to the foregoing technical solution, the third node stores information encrypted based on a public key and public object information, and a fourth node stores a private key. This ensures separation of storage permission and decryption permission. When feature information of an object is not sent out from the client, a plurality of nodes interact with each other based on an information mapping relationship. This may implement efficient information processing and effectively ensure information security. Further, the fourth node is only used to provide a decryption service. A process of information exchange between the plurality of nodes is simplified, and information processing efficiency is effectively improved.

In the foregoing technical solution, in a process of performing information deregistration, based on an information mapping relationship stored in the file information table, it is ensured that deregistration is performed on the registered feature of the to-be-deregistered object, and the deregistration process does not affect another registered feature. This implements dynamic deregistration in an encrypted state, improves flexibility of information processing, and improves information processing efficiency on a basis of ensuring information security.

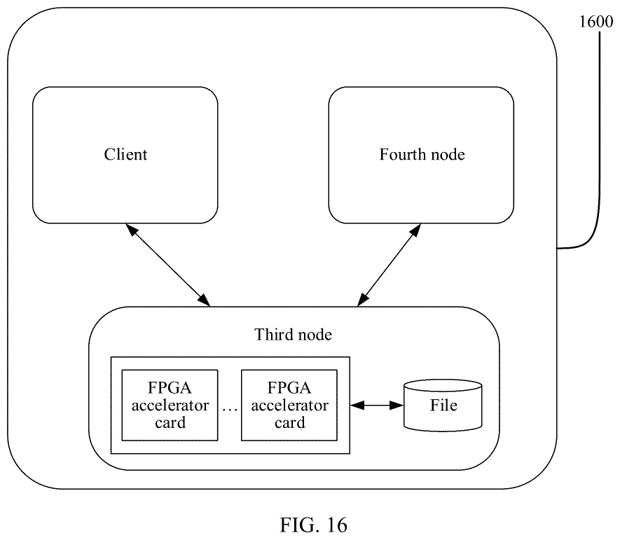

Optionally, to further improve parallel operation efficiency of the third node, configuration may be performed based on various aspects of the node. For example, based on a software aspect, OpenMP is used to implement parallel operation for data through multi-threading. For another example, based on a hardware aspect, an FPGA accelerator card is deployed in the information processing system, to improve a data parallel processing capability of the information processing system. An embodiment of this application provides a schematic diagram of an architecture of an information processing system. As shown in FIG. 16, an FPGA accelerator card is deployed in a third node of the information processing system 1600, to improve a parallelism degree of data computing performed by the third node. For an overall architecture of the information processing system 1600, refer to the information processing system 1200 corresponding to FIG. 12. Details are not described herein.

In this application, terms such as “first” and “second” are used to distinguish between same items or similar items that have basically same effects and functions. It should be understood that there is no logical or time sequence dependency between “first”, “second”, and “n^{th}”, and a quantity and an execution sequence are not limited. It should also be understood that although terms such as “first” and “second” are used in the following descriptions to describe various elements, these elements should not be limited by the terms. These terms are merely used to distinguish one element from another element. For example, without departing from the scope of the various examples described, a first client may be referred to as a second client, and similarly, a second client may be referred to as a first client. Both the first client and the second client may be clients, and in some cases, may be separate and different clients.

In this application, the term “at least one” means one or more, and in this application, the term “a plurality of” means two or more. For example, a plurality of clients mean two or more clients.

The foregoing descriptions are merely specific implementations of this application, but are not intended to limit the protection scope of this application. Any equivalent modification or replacement readily figured out by persons skilled in the art within the technical scope disclosed in this application shall fall within the protection scope of this application. Therefore, the protection scope of this application shall be subject to the protection scope of the claims.

All or some of the foregoing embodiments may be implemented by software, hardware, firmware, or any combination thereof. When software is used to implement the embodiments, all or some of the embodiments may be implemented in a form of a program product. The program product includes one or more program instructions. When the program instructions are loaded and executed on a computing device, all or some of the procedures or functions according to embodiments of this application are generated.

Persons of ordinary skill in the art may understand that all or some of the steps of embodiments may be implemented by hardware or a program instructing related hardware. The program may be stored in a computer-readable storage medium. The storage medium may be a read-only memory, a magnetic disk, an optical disc, or the like.

In the foregoing descriptions, the foregoing embodiments are merely used to describe the technical solutions of this application, but not to limit the technical solutions. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1. An information processing system, wherein the information processing system comprises: a client, a first node, and a second node;
wherein the client is configured to:
send, to the first node, a recognition request that carries number information of the client; and
send, to the second node, an encryption feature of a to-be-recognized first object and the number information of the client, wherein the encryption feature of the first object is obtained based on a public key of the first node and a feature of the first object;
wherein the first node is configured to:
determine a first target file in the second node in response to the recognition request; and
send a recognition indication to the second node, wherein the recognition indication carries the number information of the client and file information of the first target file;
wherein the second node is configured to:
in response to the recognition indication, compare the encryption feature of the first object based on the received encryption feature of the first object, the number information of the client, the file information of the first target file, and an evaluation key of the first node to obtain a comparison result; and
send the comparison result to the first node; and
wherein the first node is further configured to:
in response to receiving the comparison result, decrypt the comparison result based on a private key of the first node;
obtain object information of the first object based on a decrypted comparison result; and
send the object information of the first object to the client.

2. The system according to claim 1, wherein the client is further configured to:
perform encoding based on the feature of the first object to obtain a first feature vector of the first object, wherein the first feature vector is an M-dimensional vector;
obtain a second feature vector of the first object based on the first feature vector of the first object, wherein the second feature vector of the first object is N×M-dimensional vectors, and the second feature vector of the first object comprises N first feature vectors of the first object; and
encrypt the second feature vector of the first object based on the public key of the first node to obtain the encryption feature of the first object, wherein M and N are positive integers.

3. The system according to claim 1, wherein the second node comprises a scheduling node and a plurality of target nodes; and
wherein the first node is configured to:
determine, in a file information table based on the number information of the client in the recognition request, a first target node that corresponds to the client and that is in the second node; and
determine, in the file information table, the file information of the first target file in the first target node, wherein the file information table comprises a correspondence between the number information of the client and the plurality of target nodes comprised in the second node and a correspondence between the plurality of target nodes and files.

4. The system according to claim 3, wherein the scheduling node in the second node is configured to:
in response to the recognition indication, indicate the first target node to load the evaluation key of the first node into memory.

5. The system according to claim 3, wherein the scheduling node in the second node is configured to:
in response to the recognition indication, send the recognition indication and the encryption feature of the first object to the first target node in the second node based on the file information of the first target file when the number information received from the client is consistent with the number information of the client carried in the recognition indication.

6. The system according to claim 4, wherein the first target node in the second node is configured to perform, in a ciphertext state based on the evaluation key of the first node, an inner product operation on the received encryption feature of the first object and each registered feature in the first target file to obtain the comparison result.

7. The system according to claim 3, wherein the first node is configured to:
determine a target feature based on the decrypted comparison result, wherein the target feature is a registered feature with a maximum similarity to the feature of the first object;
obtain object information of the target feature from the file information table based on location information of the target feature in the first target file, wherein the file information table comprises object information of each registered feature in a file in the second node and location information of each registered feature in the file in the second node; and
determine the object information of the target feature as the object information of the first object.

8. The system according to claim 3, wherein:
the client is further configured to send a registration request to the first node, wherein the registration request carries the number information of the client and object information of a to-be-registered second object;
the first node is further configured to:
in response to the registration request, determine a second target file in a second target node in the second node, send file information of the second target file to the client; and
send a registration indication to the second node, wherein the registration indication carries the number information of the client and the file information of the second target file;
the client is further configured to send an encryption feature of the second object and the number information of the client to the second node, wherein the encryption feature of the second object is obtained based on the public key of the first node, a feature of the second object, and the file information of the second target file;
the second node is further configured to:
in response to the registration indication, add the encryption feature of the second object to the second target file through the second target node based on the received encryption feature of the second object, the number information of the client, the file information of the second target file, and the evaluation key of the first node; and
send addition success information to the first node; and
the first node is further configured to:
when receiving the addition success information, add the object information of the second object to the file information table; and
send registration success information to the client, wherein the file information table comprises the object information of each registered feature in the file in the second node and location information of each registered feature in the file in the second node.

9. The system according to claim 3, wherein:
the client is further configured to send a deregistration request to the first node, wherein the deregistration request carries the number information of the client and object information of a to-be-deregistered third object;
the first node is further configured to:
in response to the deregistration request, determine a third target file in which a registered feature corresponding to the third object is located in a third target node in the second node; and
send a deregistration indication to the second node, wherein the deregistration indication carries the number information of the client and file information of the third target file, the file information of the third target file comprises a location number, in the third target file, of the registered feature corresponding to the third object;
the second node is further configured to:
in response to the deregistration indication, delete, from the third target file through the third target node based on the number information of the client, the file information of the third target file, and the evaluation key of the first node, the registered feature corresponding to the third object; and
send deletion success information to the first node; and
the first node is further configured to:
when receiving the deletion success information, delete, from the file information table, the object information of the third object and location information, in the third target file, of the registered feature corresponding to the third object; and
send deregistration success information to the client, wherein the file information table comprises the object information of each registered feature in the file in the second node and the location information of each registered feature in the file in the second node.

10. An information processing method, wherein the method is performed by a client in an information processing system, the information processing system further comprises a first node and a second node, and the method comprises:
sending, to the first node, a recognition request that carries number information of the client;
sending, to the second node, an encryption feature of a to-be-recognized first object and the number information of the client, wherein the encryption feature of the first object is obtained based on a public key of the first node and a feature of the first object; and
receiving object information of the first object from the first node, wherein the object information of the first object is obtained based on the encryption feature of the first object, an evaluation key of the first node, and a private key of the first node.

11. The method according to claim 10, wherein before the sending an encryption feature of a to-be-recognized first object and the number information of the client to the second node, the method further comprises:
performing encoding based on the feature of the first object to obtain a first feature vector of the first object, wherein the first feature vector is an M-dimensional vector;
obtaining a second feature vector of the first object based on the first feature vector of the first object, wherein the second feature vector of the first object is N×M-dimensional vectors, and the second feature vector of the first object comprises N first feature vectors of the first object; and
encrypting the second feature vector of the first object based on the public key of the first node, to obtain the encryption feature of the first object, wherein M and N are positive integers.

12. The method according to claim 10, wherein the method further comprises:
sending a registration request to the first node, wherein the registration request carries the number information of the client and object information of a to-be-registered second object;
sending an encryption feature of the second object and the number information of the client to the second node, wherein the encryption feature of the second object is obtained based on the public key of the first node, a feature of the second object, and file information of a second target file in the second node, and the file information of the second target file is determined by the first node in response to the registration request; and
receiving registration success information from the first node.

13. The method according to claim 12, wherein the file information of the second target file comprises a vacant location number of the second target file, and before the sending an encryption feature of the second object and the number information of the client to the second node, the method further comprises:
performing encoding based on the feature of the second object to obtain a first feature vector of the second object, wherein the first feature vector of the second object is an M-dimensional vector;
obtaining a second feature vector of the second object based on the first feature vector of the second object and the vacant location number, wherein the second feature vector of the second object is N×M-dimensional vectors, the first feature vector of the second object is located at a location that corresponds to the vacant location number and that is in the second feature vector of the second object, and a location other than the location that corresponds to the vacant location number and that is in the second feature vector of the second object is 0; and
encrypting the second feature vector of the second object based on the public key of the first node, to obtain the encryption feature of the second object, wherein M and N are positive integers.

14. The method according to claim 10, wherein the method further comprises:
sending a deregistration request to the first node, wherein the deregistration request carries the number information of the client and object information of a to-be-deregistered third object; and
receiving deregistration success information from the first node.

15. A first node of a system, wherein the first node comprises:
at least one processor; and
at least one memory coupled to the at least one processor and storing programming instructions for execution by the at least one processor to:
determine a first target file in a second node of a system in response to a recognition request that is received from a client that carries number information of the client,
send a recognition indication to the second node, wherein the recognition indication carries the number information of the client and file information of the first target file;
decrypt a comparison result based on a private key of the first node when receiving the comparison result from the second node;
obtain object information of a first object based on the decrypted comparison result; and
send the object information of the first object to the client, wherein the comparison result is obtained from the second node which performs, in response to the recognition indication, comparison on an encryption feature of the first object based on the encryption feature of the first object, the number information of the client, the file information of the first target file, and an evaluation key of the first node.

16. The first node according to claim 15, wherein the second node comprises a scheduling node and a plurality of target nodes, and the determining a first target file in a second node in response to a recognition request that is received from a client that carries number information of the client comprises:
determining, in a file information table based on the number information of the client in the recognition request, a first target node that corresponds to the client and that is in the second node; and
determining, in the file information table, the file information of the first target file in the first target node, wherein the file information table comprises a correspondence between the number information of the client and the plurality of target nodes comprised in the second node, and a correspondence between the plurality of target nodes and files.

17. The first node according to claim 16, wherein the obtaining object information of a first object based on the decrypted comparison result comprises:
determining, by the first node, a target feature based on the decrypted comparison result, wherein the target feature is a registered feature with a maximum similarity to the feature of the first object;
obtaining object information of the target feature from the file information table based on location information of the target feature in the first target file, wherein the file information table comprises object information of each registered feature in a file in the second node and location information of each registered feature in the file in the second node; and
determining the object information of the target feature as the object information of the first object.

18. The first node according to claim 16, wherein the programming instructions are for execution by the at least one processor to perform operations comprising:
in response to a registration request received from the client, determining a second target file in a second target node in the second node, sending file information of the second target file to the client, and sending a registration indication to the second node, wherein the registration request carries the number information of the client and object information of a to-be-registered second object, and the registration indication carries the number information of the client and the file information of the second target file; and
when receiving addition success information from the second node, adding the object information of the second object to the file information table, and sending registration success information to the client, wherein the file information table comprises the object information of each registered feature in the file in the second node and location information of each registered feature in the file in the second node, and the addition success information indicates that an encryption feature of the second object has been added to the second target file.

19. The first node according to claim 16, wherein the programming instructions are for execution by the at least one processor to perform operations comprising:
in response to a deregistration request received from the client, determining a third target file in which a registered feature corresponding to a third object is located in a third target node in the second node, and sending a deregistration indication to the second node, wherein the deregistration indication carries the number information of the client and file information of the third target file, and the deregistration request carries the number information of the client and object information of a to-be-deregistered third object; and
when receiving deletion success information from the second node, deleting, from the file information table, the object information of the third object and location information, in the third target file, of the registered feature corresponding to the third object, and sending deregistration success information to the client, wherein the file information table comprises the object information of each registered feature in the file in the second node and the location information of each registered feature in the file in the second node, and the deletion success information indicates that the registered feature corresponding to the third object has been deleted from the third target file.
